(19) United States
(12) Patent Application Publication
(10) Pub. No.: US 2024/0098540 A1
(43) Pub. Date: Mar. 21, 2024

(54) ACTIVATION/DEACTIVATION OF PRECONFIGURED MEASUREMENT GAPS

(71) Applicant: Telefonaktiebolaget LM Ericsson (publ), STOCKHOLM (SE)

(72) Inventors: Muhammad Ali Kazmi, SUNDBYBERG (SE); Iana Siomina, TÄBY (SE); Joakim Axmon, LIMHAMN (SE)

(21) Appl. No.: 18/271,585

(22) PCT Filed: Jan. 6, 2022
(86) PCT No.: PCT/IB2022/050096

§ 371 Date: Jul. 10, 2023

Related U.S. Application Data
(60) Provisional application No. 63/135,400, filed on Jan. 8, 2021.

(51) Int. Cl. H04W 24/10; H04L 5/00

(52) U.S. Cl. CPC H04W 24/10; H04L 5/0048; H04L 5/0096

(57) ABSTRACT

Systems and methods for activation and/or deactivation of preconfigured measurement gaps are disclosed. In one embodiment, a method performed by a User Equipment (UE) comprises receiving, from a network node, information that indicates one or more pre-configured measurement gap patterns. The method further comprises determining that a first set of one or more conditions for using a pre-configured measurement gap pattern is satisfied, the pre-configured measurement gap pattern being one of the one or more pre-configured measurement gap patterns. The method further comprises determining a time instance at which to start using the pre-configured measurement gap pattern and starting performance of a measurement using the pre-configured measurement gap pattern at or after the determined time instance. In this manner, the UE is enabled to activate a preconfigured measurement gap pattern in response to the first set of one or more conditions for using the pre-configured measurement gap pattern being satisfied.

### RELATED APPLICATIONS

This application claims the benefit of United States Provisional Patent Application No. 63/135,400, filed Jan. 8, 2021, the disclosure of which is hereby incorporated herein by reference in its entirety.

### TECHNICAL FIELD

The present disclosure relates to performing measurements in a cellular communications system.

### BACKGROUND

### Bandwidth Part Operation

In Third Generation Partnership Project (3GPP) New Radio (NR), to enable the User Equipment (UE) power saving and avoid interference, the UE can be configured by the higher layer with a set of bandwidth parts (BWPs) for signal receptions (e.g., Physical Downlink Control Channel (PDCCH), Physical Downlink Shared Channel (PDSCH), etc.) by the UE in a serving cell e.g., Special Cell (SpCell) (e.g., Primary Cell (PCell), Primary Secondary Cell (PSCell)), Serving Cell (SCell), etc. and a set of BWPs for signal transmissions (e.g., Physical Uplink Control Channel (PUCCH), Physical Uplink Shared Channel (PUSCH)) by the UE in a serving cell. The set of BWPs for signal receptions by the UE is referred to as a downlink (DL) BWP set and may include, e.g., up to four DL BWPs. The set of BWPs for signal transmissions by the UE is referred to as an uplink (UL) BWP set and may include, e.g., up to four UL BWPs.

Each BWP can be associated with multiple parameters. Examples of such parameters are: bandwidth (BW) (e.g., number of time-frequency resources (e.g., resource blocks such as 25 Physical Resource Blocks (PRBs), etc.), location of the BWP in frequency (e.g., starting resource block (RB) index of the BWP or center frequency of the BWP, etc.), subcarrier spacing (SCS), cyclic prefix (CP) length, any other baseband parameter (e.g., Multiple Input Multiple Output (MIMO) layer, receivers, transmitters, Hybrid Automatic Repeat Request (HARQ) related parameters, etc.), etc.

The UE is served (e.g., receives signals such as PDCCH, PDSCH and transmits signals such as PUCCH, PUSCH) in a serving cell only on the active BWP(s). At least one of the configured DL BWPs can be active for reception and at least one of the configured UL BWPs can be active for transmission, in each serving cell. The UE can be configured to switch the active BWP based on a timer (e.g., BWP inactivity timer such as bwp-InactivityTimer), by receiving a command or a message from another node (e.g., from the base station (BS)), etc. Examples of such a command or message are DL control information (DCI) sent on PDCCH, Radio Resource Control (RRC) message, Medium Access Control (MAC) command, etc. Any active BWP can be switched independently, e.g., UL and DL active BWPs can be switched separately. The active BWP switching operation may involve change in one or more parameters associated with the BWP described above, e.g., BW, frequency location, SCS, etc. For example, when the timer (e.g., bwp-InactivityTimer) expires, the UE is required to switch to a reference active BWP, e.g., a default active BWP, one of the configured BWPs, etc. In another example, when the UE receives a DCI command to switch active BWP, then the UE is required to switch its current active BWP to one of the configured BWPs indicated in the command. In yet another example, when the UE receives an RRC message to switch active BWP, then the UE is required to switch its current active BWP to a new BWP indicated in the RRC message; this may also be referred to as reconfiguration of the active BWP. The BWP switching may also comprise, when the UE is configured with an active BWP for the first time, e.g., when entering RRC connected state.

An example of active BWP switching is illustrated in FIG. 1. For example, the UE is configured with four different BWPs: BWP1, BWP2, BWP3, and BWP4, which are associated with different sets of parameters, e.g., BW, SCS, frequency location, etc. The UE can be configured to switch its active BWP based on any of timer, DCI command, or RRC message (which also includes RRC procedure delay, e.g., 10 ms). For example, the UE is switched first from the current active BWP1 to new BWP2, which becomes the new active BWP. The active BWP2 is further switched to BWP3, which in turn becomes the new active BWP. The active BWP3 is then further switched to BWP4, which in turn becomes the new active BWP. The active BWP switching involves delay, e.g., X number of slots. This active BWP switching delay depends on one or multiple factors, e.g., type of BWP switching, numerology of BWP before and after the switching, number of serving cells on which the BWP switching is triggered simultaneously, number of serving cells on which the BWP switching is triggered non-simultaneously (e.g., over partially overlapping time periods), etc.

### Radio Resource Management (RRM) Measurements in NR

In NR, the Reference Signals (RS) (e.g., Synchronization Signal Block (SSB), Channel State Information Reference Signal (CSI-RS), Positioning Reference Signal (PRS), etc.) are used by the UE for performing different types of measurements for different purposes, e.g., for mobility, for Radio Link Monitoring (RLM) related procedure, for beam management (BM) related procedure, for positioning, for scheduling and link adaptation, etc. Mobility measurements are done on RS of serving and neighbor cells. Examples of mobility measurements are cell detection or cell identification, signal quality, signal strength, etc. Specific examples of signal strength measurements are path loss, received signal power, Reference Signal Received Power (RSRP), Synchronization Signal RSRP (SS-RSRP), etc. Specific examples of signal quality measurements are received signal quality, Reference Signal Received Quality (RSRQ), Signal to Interference plus Noise Ratio (SINR), Synchronization Signal RSRQ (SS-RSRQ), Synchronization Signal SINR (SS-SINR), Signal to Noise Ratio (SNR), etc. Examples of RLM related measurements are out of sync (OOS) detection, in sync (IS) detection, etc. Examples of BM related measurements are beam failure detection, candidate beam detection, L1-RSRP, etc. Examples of measurements for scheduling and link adaptation are channel state information (CSI) measurements, e.g., channel quality indicator (CQI), rank indicator (RI), precoding matrix indicator (PMI), etc.

In NR, in one example, the UE can be configured to perform and report measurements on one or more beams in a cell, i.e. beam level measurement. In this case, the UE may measure on a beam and transmits measurement results comprising, e.g., signal measurement (e.g., SS-RSRP) of the beam and the beam index (e.g., SSB index, CSI-RS index, etc.).

In another example, the UE can be configured to perform and report measurements on one or more cells, i.e. cell level measurement. In this case, the UE may measure one or more beams, derive cell level measurement results, and transmit the cell level measurement results comprising, e.g., signal measurement (e.g., SS-RSRP) of the cell. The beam level measurement results of one or more beams are averaged by the UE to derive the cell level measurement.

### Measurement Gap Pattern

Measurement gap pattern (MGP) is used by the UE for performing measurements on cells of the serving carriers and non-serving carriers (e.g., inter-frequency carrier, inter-Radio Access Technology (RAT) carriers, etc.). In NR, measurement gaps are used for measurements on cells of the serving carrier in some scenarios, e.g., if the measured signals (e.g., SSB, CSI-RS, PRS, etc.) are not fully within the active bandwidth part (BWP) of the serving cell. The UE is scheduled in the serving cell only within the BWP. During the measurement gap, the UE cannot be scheduled for receiving/transmitting signals in one or more serving cells. A MGP is characterized or defined by several parameters: measurement gap length (MGL), measurement gap repetition period (MGRP), and measurement gap time offset with respect to a reference time (e.g., slot offset with respect to the serving cell's System Frame Number (SFN) such as SFN=0). MGRP is also referred to as a measurement gap periodicity. An example of a MGP is shown in FIG. 2. As an example, MGL can be 1.5 ms, 3 ms, 3.5 ms, 4 ms, 5.5 ms, 6 ms, 10 ms, 20 ms, etc., and MGRP can be 20 ms, 40 ms, 80 ms, or 160 ms. Such type of MGP is configured by the network node and is also called as network controlled or network configurable MGP. Therefore, the serving base station is fully aware of the timing of each gap within the MGP. Measurement gaps may also be configured/applicable for a specific purpose, e.g., RRM measurements, positioning measurements, RLM, beam management, etc.

The measurement gaps can be UE specific or carrier specific. In the former case, the measurement gaps are created on all serving cells of the UE. In the latter case, the measurement gaps are created only on a subset of serving cells of the UE, e.g., on serving cells operating on carriers of specific frequency range (FR). Therefore, carrier specific gaps are also referred to as per FR gaps, e.g., per FR1, per FR2, etc.

All UEs support per UE gaps. Whether UE also supports carrier specific or per FR gaps depends on UE capability.

### Measurements During NR SCell Dormancy

NR SCells may be configured to the UE in either deactivated or activated state. In deactivated state, the UE only carries out RRM measurements (mobility measurements, e.g., on SSBs) according to a sparse measurement schedule proportional to a configured measurement cycle of length 160, 320, 640, or 1280 ms.

In activated state, the UE may operate according to non-dormant or dormant behavior. Whether the UE operates according to non-dormant or dormant behavior with respect to the SCell is determined by whether the active downlink BWP is a non-dormant (sometimes called normal) BWP, or whether the active BWP is a dormant BWP. Switching between non-dormant and dormant BWPs is carried out by the base station via signaling using a DCI format on the SpCell for the cell group (PCell for MCG, and PSCell for SCG). When the UE is configured with an active BWP which is a dormant BWP for the SCell, one may alternatively refer to that the SCell is dormant, that the serving carrier is dormant, or that any of them is in dormancy.

When the active BWP is a non-dormant BWP, the UE carries out normal operations associated with a fully active SCell. This includes, e.g., monitoring PDCCH, receiving on PDSCH, carrying out RRM measurements (mobility measurements, e.g., on SSB), CSI measurements (e.g., on CSI-RS), and executing control loops, e.g., Automatic Gain Control (AGC), Automatic Frequency Control (AFC), and tracking timing of the SCell. If the SCell is associated also with an uplink, the normal operations additionally include transmitting in the SCell, e.g., on PUCCH and/or PUSCH.

When the active BWP is a dormant BWP, the UE is only carrying out, e.g., RRM measurements, CSI measurements, and executing control loops for the SCell, i.e. the UE is not monitoring PDCCH etc.

In order for the UE to save power when operating according to dormant behavior, the UE is allowed to cause autonomous interruptions in reception and transmission on other serving carriers for turning radio reception on and off for measurements on the SCell. In 3GPP Release 16, the UE is allowed to cause interruptions on a serving carrier of up to 1% of slots for CSI measurements, and up to 1.5% of slots for RRM measurements. Since the interruptions are autonomous, the base station does not know when they occur and hence cannot account for it when scheduling the UE on downlink and/or uplink on serving carriers.

For RRM measurements on SSBs, it is assumed that, even if SSBs would be provided more frequently, it is sufficient for the UE to carry out measurements at most every 40 ms, whereby five samples would comprise a 200 ms measurement period. This would not change when the UE is switching between non-dormant and dormant behavior with respect to the SCell. For CSI measurements, CSI-RS and CSI measurement configurations are provided per BWP. The periodicity of CSI-RS and hence of CSI measurements, as well as other properties, therefore may differ between non-dormant and dormant BWPs.

### SUMMARY

Systems and methods for activation and/or deactivation of preconfigured measurement gaps are disclosed. In one embodiment, a method performed by a User Equipment (UE) comprises receiving, from a network node, information that indicates one or more pre-configured measurement gap patterns. The method further comprises determining that a first set of one or more conditions for using a pre-configured measurement gap pattern is satisfied, the pre-configured measurement gap pattern being one of the one or more pre-configured measurement gap patterns. The method further comprises determining a time instance at which to start using the pre-configured measurement gap pattern and starting performance of a measurement using the pre-configured measurement gap pattern at or after the determined time instance. In this manner, the UE is enabled to activate a preconfigured measurement gap pattern in response to the first set of one or more conditions for using the pre-configured measurement gap pattern being satisfied.

In one embodiment, the method further comprises performing a measurement without pre-configured measurement gap pattern before the first set of one or more conditions for using a pre-configured measurement gap pattern is satisfied. Starting performance of the measurement using the pre-configured measurement gap pattern at the determined time instance comprises continuing performing the measurement with the pre-configured measurement gap pattern at or after the determined time instance. In one embodiment, performing the measurement without pre-configured measurement gap pattern comprises performing the measurement without pre-configured measurement gap pattern within the active bandwidth part of the UE.

In one embodiment, the information that indicates the one or more pre-configured measurement gap patterns comprises, for each pre-configured measurement gap pattern of the one or more pre-configured measurement gap patterns, information that indicates one or more parameters that define the pre-configured measurement gap pattern. In one embodiment, the one or more parameters comprise a measurement gap length, a measurement gap repetition period, and a measurement gap time offset with respect to a reference time.

In one embodiment, the first set of one or more conditions comprises a condition that one or more reference signals used for the measurements are not fully within a bandwidth of an active bandwidth part of the UE.

In one embodiment, the method further comprises performing a measurement in an active bandwidth part of the UE and performing an active bandwidth part switching procedure to a new active bandwidth part. The first set of one or more conditions comprises a condition that one or more reference signals used for the measurement are not fully within a bandwidth of the new active bandwidth part of the UE.

In one embodiment, the first set of one or more conditions comprises a condition that the UE is configured to perform the measurement on an active bandwidth part of the UE and one or more reference signals used for the measurement are not fully within a bandwidth of the active bandwidth part of the UE.

In one embodiment, the determined time instance at which to start using the pre-configured measurement gap pattern is a reference time, T0, plus a time offset, DT1. In one embodiment, the reference time, T0, is a time at which the UE received a request to perform the measurement, a time at which the UE informed a network node that the UE will use the pre-configured measurement gap pattern, or a time at which the UE receives a message from a network node that indicates that the UE is permitted to use the pre-configured measurement gap pattern.

In one embodiment, the first set of one or more conditions comprises a condition that the UE is switched from non-dormant to dormant bandwidth part. In one embodiment, the determined time instance at which to start using the pre-configured measurement gap pattern is a reference time, T0, plus a time offset, DT1, and the reference time, T0, is a time at which the UE was switched from non-dormant to dormant BWP or a time at which switching of the UE from non-dormant to dormant BWP is complete.

In one embodiment, determining the time instance at which to start using the pre-configured measurement gap pattern comprises determining the time instance at which to start using the pre-configured measurement gap pattern based on one or more predefined rules and/or information received from a network node about one or more parameters related to the determined time instance.

In one embodiment, determining the time instance at which to start using the pre-configured measurement gap pattern comprises determining the time instance at which to start using the pre-configured measurement gap pattern autonomously at the UE.

In one embodiment, starting the use of the pre-configured measurement gap pattern comprises activating the pre-configured measurement gap pattern.

In one embodiment, the method further comprises determining a time instance at which to stop using the pre-configured measurement gap pattern.

In one embodiment, the method further comprises performing a measurement using a preconfigured measurement gap pattern which is one of the one or more pre-configured measurement gap patterns, determining that a second set of one or more conditions for stopping use of a pre-configured measurement gap pattern is satisfied, and stopping use of the pre-configured measurement gap pattern at the determined time instance at which to stop using the pre-configured measurement gap pattern.

In one embodiment, the method further comprises performing a measurement using a preconfigured measurement gap pattern which is one of the one or more pre-configured measurement gap patterns, determining that a second set of one or more conditions for stopping use of a pre-configured measurement gap pattern is satisfied, determining a time instance at which to stop using the pre-configured measurement gap pattern, and stopping use of the pre-configured measurement gap pattern at the determined time instance at which to stop using the pre-configured measurement gap pattern.

In one embodiment, the method further comprises performing the ongoing measurement without pre-configured measurement gap pattern at or after the determined time instance at which to stop using the pre-configured measurement gap pattern. In one embodiment, performing the measurement without pre-configured measurement gap pattern comprises performing the measurement within the active bandwidth part of the UE.

In one embodiment, the second set of one or more conditions comprises a condition that one or more reference signals used for the measurement are fully within a bandwidth of an active bandwidth part of the UE.

In one embodiment, the method further comprises performing an active bandwidth part switching procedure to a new active bandwidth part, wherein the second set of one or more conditions comprises a condition that one or more reference signals used for the measurement are fully within a bandwidth of the new active bandwidth part of the UE.

In one embodiment, the determined time instance at which to stop using the pre-configured measurement gap pattern is a reference time, T0, plus a time offset, DT2.

In one embodiment, determining the time instance at which to stop using the pre-configured measurement gap pattern comprises determining the time instance at which to stop using the pre-configured measurement gap pattern based on one or more predefined rules and/or information received from a network node about one or more parameters related to the determined time instance.

In one embodiment, determining the time instance at which to stop using the pre-configured measurement gap pattern comprises determining the time instance at which to stop using the pre-configured measurement gap pattern autonomously at the UE.

In one embodiment, the second set of one or more conditions comprises a condition that a number of active bandwidth part switches that has occurred in a respective cell during a defined or (pre-)configured time period is less than a threshold number.

In one embodiment, the second set of one or more conditions comprises a condition that is based on a time period between successive active bandwidth part switches that require the UE to change between a bandwidth part measurement procedure that does not use measurement gaps and a gap based measurement procedure that does use measurement gaps.

In one embodiment, the second set of one or more conditions comprises a condition that is based on a time period over which the UE has been using a gap based measurement procedure for performing the measurement.

In one embodiment, stopping the use of the pre-configured measurement gap pattern comprises deactivating the pre-configured measurement gap pattern.

In one embodiment, the UE is able to receive and/or transmit signals during measurement gaps defined by the pre-configured measurement gap pattern when the pre-configured measurement gap pattern is not used by the UE.

Corresponding embodiments of a UE are also disclosed. In one embodiment, a UE is adapted to receive, from a network node, information that indicates one or more pre-configured measurement gap patterns, determine that a first set of one or more conditions for using a pre-configured measurement gap pattern is satisfied where the pre-configured measurement gap pattern being one of the one or more pre-configured measurement gap patterns, determine a time instance at which to start using the pre-configured measurement gap pattern, and start performance of a measurement using the pre-configured measurement gap pattern at or after the determined time instance.

In one embodiment, a UE comprises one or more transmitters, one or more receivers, and processing circuitry associated with the one or more transmitters and the one or more receivers. The processing circuitry is configured to cause the UE to receive, from a network node, information that indicates one or more pre-configured measurement gap patterns, determine that a first set of one or more conditions for using a pre-configured measurement gap pattern is satisfied where the pre-configured measurement gap pattern being one of the one or more pre-configured measurement gap patterns, determine a time instance at which to start using the pre-configured measurement gap pattern, and start performance of a measurement using the pre-configured measurement gap pattern at or after the determined time instance.

In another embodiment, a method performed by a UE comprises receiving, from a network node, information that indicates one or more pre-configured measurement gap patterns, determining that a third set of one or more conditions for using a pre-configured measurement gap pattern is satisfied where the pre-configured measurement gap pattern is one of the one or more pre-configured measurement gap patterns, determining a time duration over which to use the pre-configured measurement gap pattern, and performing a measurement using the pre-configured measurement gap pattern over the determined time duration.

In one embodiment, the information that indicates the one or more pre-configured measurement gap patterns comprises, for each pre-configured measurement gap pattern of the one or more pre-configured measurement gap patterns, information that indicates one or more parameters that define the pre-configured measurement gap pattern. In one embodiment, the one or more parameters comprise a measurement gap length, a measurement gap repetition period, and a measurement gap time offset with respect to a reference time.

In one embodiment, the UE is able to receive and/or transmit signals during measurement gaps defined by the pre-configured measurement gap pattern when the pre-configured measurement gap pattern is not used by the UE.

Corresponding embodiments of a UE are also disclosed. In one embodiment, a UE is adapted to receive, from a network node, information that indicates one or more pre-configured measurement gap patterns, determine that a third set of one or more conditions for using a pre-configured measurement gap pattern is satisfied where the pre-configured measurement gap pattern is one of the one or more pre-configured measurement gap patterns, determine a time duration over which to use the pre-configured measurement gap pattern, and perform a measurement using the pre-configured measurement gap pattern over the determined time duration.

In one embodiment, a UE comprises one or more transmitters, one or more receivers, and processing circuitry associated with the one or more transmitters and the one or more receivers. The processing circuitry is configured to cause the UE to receive, from a network node, information that indicates one or more pre-configured measurement gap patterns, determine that a third set of one or more conditions for using a pre-configured measurement gap pattern is satisfied where the pre-configured measurement gap pattern is one of the one or more pre-configured measurement gap patterns, determine a time duration over which to use the pre-configured measurement gap pattern, and perform a measurement using the pre-configured measurement gap pattern over the determined time duration.

Embodiments of a method performed by a network node are also disclosed. In one embodiment, a method performed by a network node for a cellular communications system comprises providing, to a UE, information that indicates one or more pre-configured measurement gap patterns and providing, to the UE, information that indicates a time instance at which to start using the pre-configured measurement gap pattern.

In one embodiment, the method further comprises providing, to the UE, information that indicates a time instance at which to stop using the pre-configured measurement gap pattern.

In one embodiment, the information that indicates the one or more pre-configured measurement gap patterns comprises, for each pre-configured measurement gap pattern of the one or more pre-configured measurement gap patterns, information that indicates one or more parameters that define the pre-configured measurement gap pattern. In one embodiment, the one or more parameters comprise a measurement gap length, a measurement gap repetition period, and a measurement gap time offset with respect to a reference time.

In one embodiment, the network node does not schedule the UE (312) during the one or more pre-configured measurement gap patterns when the one or more pre-configured measurement gap patterns are used by the UE.

Corresponding embodiments of a network node are also disclosed. In one embodiment, a network node for a cellular communications system is adapted to provide, to a UE, information that indicates one or more pre-configured measurement gap patterns and provide, to the UE, information that indicates a time instance at which to start using the pre-configured measurement gap pattern.

In one embodiment, a network node for a cellular communications system comprises processing circuitry configured to cause the network node to provide, to a UE, information that indicates one or more pre-configured measurement gap patterns and provide, to the UE, information that indicates a time instance at which to start using the pre-configured measurement gap pattern.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of Bandwidth Part (BWP) switching;

FIG. 2 illustrates one example of measurement gap periodicity (MGP);

FIG. 3 illustrates one example of a cellular communications system in which embodiments of the present disclosure may be implemented;

FIG. 4 illustrates an example in which a User Equipment (UE) is pre-configured with MGP to perform measurements, in accordance with an embodiment of the present disclosure;

FIG. 5 is an example to illustrate the meaning of a time instance (Tg) at which a UE will switch to a gap-based measurement procedure (GMP) for measurements since conditions or criteria for using GMP are triggered in accordance with an embodiment of the present disclosure;

FIG. 6 illustrates the operation of a UE and a network node in accordance with at least some aspects of a first embodiment of the present disclosure;

FIG. 7 is an example to illustrate the meaning of a time instance (Tb) at which a UE will stop GMP for measurements since conditions or criteria for using a Bandwidth Part (BWP) based measurement procedure (BMP) were triggered in accordance with an embodiment of the present disclosure;

FIG. 8 illustrates the operation of a UE and a network node in accordance with at least some aspects of a second embodiment of the present disclosure;

FIG. 9 illustrates the operation of a UE and a network node in accordance with at least some aspects of a third embodiment of the present disclosure;

FIGS. 10, 11, and 12 are schematic block diagrams of example embodiments of a network node;

FIGS. 13 and 14 are schematic block diagrams of example embodiments of a UE.

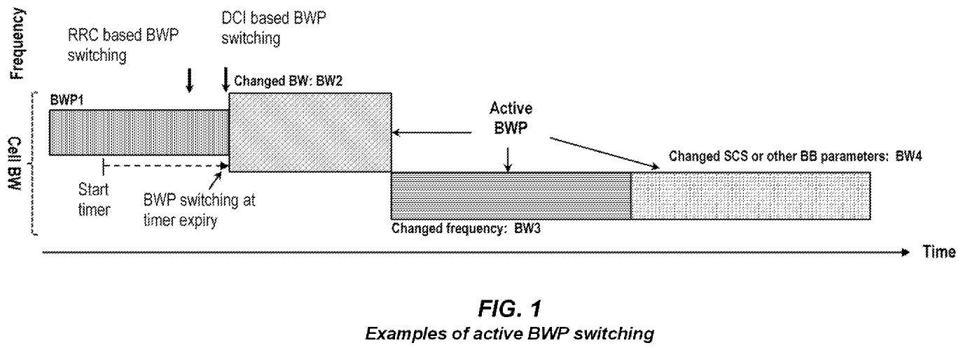

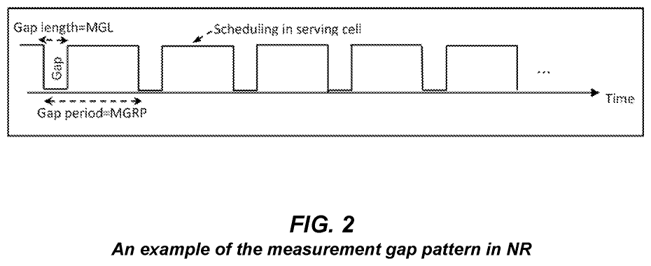

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

As used herein, the term “node” is used to refer to either a network node or a user equipment (UE).

Examples of network nodes are NodeB, base station (BS), multi-standard radio (MSR) radio node such as MSR BS, eNodeB (eNB), gNodeB (gNB), Master eNB (MeNB), Secondary eNB (SeNB), location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, transmission reception point (TRP), Remote Radio Unit (RRU), Remote Radio Head (RRH), nodes in distributed antenna system (DAS), core network node (e.g., Mobile Switching Center (MSC), Mobility Management Entity (MME), etc.), Operations and Management (O&M), Operations Support System (OSS), Self-Organizing Network (SON), positioning node (e.g., Evolved Serving Mobile Location Center (E-SMLC)), etc.

The non-limiting term “UE” refers to any type of wireless device communicating with a network node and/or with another UE in a cellular or mobile communication system. Examples of UE are target device, device to device (D2D) UE, vehicular to vehicular (V2V) device, machine type UE, Machine Type Communication (MTC) UE or UE capable of machine to machine (M2M) communication, Personal Digital Assistant (PDA), tablet, mobile terminals, smart phone, laptop embedded equipment (LEE), laptop mounted equipment (LME), Universal Serial Bus (USB) dongles, etc.

The term “radio access technology”, or “RAT”, may refer to any RAT, e.g., Universal Terrestrial Radio Access (UTRA), Evolved UTRA (E-UTRA), narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term “signal” or “radio signal” used herein can be any physical signal or physical channel. Examples of downlink (DL) physical signals are reference signal (RS) such as Primary Synchronization Signal (PSS), Secondary Synchronization Signal (SSS), Channel State Information Reference Signal (CSI-RS), Demodulation Reference Signal (DMRS) signals in Synchronization Signal (SS)/Physical Broadcast Channel (PBCH) Block (SSB), Discovery Reference Signal (DRS), Cell-specific Reference Signal (CRS), Positioning Reference Signal (PRS), etc. RS may be periodic, e.g., RS occasion carrying one or more RSs may occur with certain periodicity, e.g., 20 milliseconds (ms), 40 ms, etc. The RS may also be aperiodic. Each SSB carries NR PSS (NR-PSS), NR SSS (NR-SSS), and NR PBCH (NR-PBCH) in four successive symbols. One or multiple SSBs are transmitted in one SSB burst which is repeated with certain periodicity, e.g., 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with regard to reference time (e.g., serving cell's SFN), etc. Therefore, SMTC occasion may also occur with certain periodicity, e.g., 5 ms, 10 ms, 20 ms, 40 ms, 80 ms, and 160 ms. Examples of uplink (UL) physical signals are reference signal such as Sounding Reference Signal (SRS), DMRS, etc. The term physical channel refers to any channel carrying higher layer information, e.g., data, control, etc. Examples of physical channels are PBCH, Narrowband PBCH (NPBCH), Physical Downlink Control Channel (PDCCH), Physical Downlink Shared Channel (PDSCH), Physical Uplink Control Channel (PUCCH), short PDSCH (sPDSCH), short PUCCH (sPUCCH), short Physical Uplink Shared Channel (sPUSCH), MTC PDCCH (MPDCCH), Narrowband PDCCH (NPDCCH), Narrowband PDSCH (NPDSCH), Enhanced PDCCH (E-PDCCH), Physical Uplink Shared Channel (PUSCH), Narrowband PUSCH (NPUSCH), etc.

The term “time resource” used herein may correspond to any type of physical resource or radio resource expressed in terms of length of time. Examples of time resources are: symbol, time slot, subframe, radio frame, Transmit Time Interval (TTI), interleaving time, slot, sub-slot, mini-slot, etc.

A generic term “active BWP switching” is used herein refer to switching between any two Bandwidth Parts (BWPs) in DL and/or in UL of a serving cell. The active BWP switching may also comprise switching between non-dormant BWP and dormant BWP on a serving cell, e.g., SCell. In serving cell with a dormant BWP, the UE is not expected to monitor the control channels but only performs measurements, e.g., Radio Resource Management (RRM), Channel State Information (CSI), etc. In a non-dormant BWP, the UE is expected to monitor the control channels as well as perform other tasks, e.g., measurements. The active BWP switching may also be called as active BWP change, active BWP modification or simply BWP switching etc.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In NR, the UE can be configured to perform measurements (e.g., intra-frequency measurements) within the active BWP (e.g., on serving carrier frequency) provided that the reference signals (RS s), e.g., SSB, used for measurements are within the bandwidth (BW) of the active BWP. The base station can, at any time, request the UE to switch its active BWP, e.g., due to scheduling, enable UE power saving, reduce interference, etc. However, after the active BWP switching, it cannot be guaranteed that measured RSs will be fully within the BW of the new active BWP (i.e., after the switching). In order to ensure that the UE continues doing measurements, the base station needs to configure measurement gaps. However, the measurement gap configuration process involves signaling overheads and processing in the UE and base station. Furthermore, active BWP can be switched any time. To speed up the process, the UE can be configured with pre-configured measurement gaps, which can be used by the UE upon active BWP switching. However, currently there are no rules defining the UE behavior for switching between measurements within active BWP and measurements using gaps. Without such rules, the UE may, at any time, switch between the two measurement mechanisms, which leads to uncertainty in scheduling, uncontrolled dropped transmissions and receptions, unpredictable delays, and misalignments between actual UE operation and network assumptions about this, etc. This will result in loss of scheduling resources in the serving cell and degrade the performance, e.g., reduce user and system throughput. This will also degrade the measurement performance.

Certain aspects of the present disclosure and their embodiments may provide solutions to the aforementioned or other challenges. Embodiments of systems and methods are disclosed herein in which a UE is pre-configured with at least one measurement gap pattern whose usage for measurement is activated or deactivated based on fulfilling one or more conditions or criteria, e.g., based on BWP switching. Typically, a measurement gap pattern is configured by the network node when the UE is triggered or configured to perform a certain type of measurement, e.g., inter-frequency, inter-RAT, positioning, etc. The term “pre-configured measurement gap pattern” or “pre-configured gaps” may refer to any type of measurement gap pattern (e.g., existing pattern), which is configured at the UE even before the UE needs to use the gaps for a certain measurement. This reduces delay in setting up gaps when a new measurement or an ongoing measurement is to be done or continued using gaps.

In a first embodiment, a UE is pre-configured with at least one measurement gap pattern that is not being used for measurement. The UE, upon fulfilling a first set (S1) of one or more conditions or criteria, obtains information about a time instance (Tg) at which the UE is to start using the pre-configured measurement gap pattern and starts using the pre-configured measurement gap pattern for performing one or more measurements at the obtained time instance (Tg). In one embodiment, the meeting of the first set (S1) of one or more conditions or criteria requires the UE to start using the pre-configured measurement gap pattern. The UE may further transmit the obtained information of Tg to another node, e.g., to a network node, to another UE, etc.

In a second embodiment, a UE is using at least one pre-configured measurement gap pattern. The UE, upon fulfilling a second set (S2) of one or more conditions or criteria, obtains information about a time instance (Tb) at which the UE is to stop using the pre-configured measurement gap pattern for performing one or more measurements and stops using the pre-configured measurement gap pattern at the obtained second time instance (Tb). In one embodiment, the UE may further start performing the ongoing measurements within the active BWP at or after Tb, i.e. performing measurement without measurement gaps. In one embodiment, the meeting of the second set (S2) of one or more conditions or criteria requires the UE not to use the pre-configured measurement gap pattern. The UE may further transmit the obtained information of Tb to another node, e.g., to a network node, to another UE etc.

In a third embodiment, a UE is pre-configured with at least one measurement gap pattern and, upon fulfilling a third set (S3) of one or more conditions or criteria, obtains information about the time duration (Tx) during which the UE is to use the pre-configured measurement gap pattern for performing one or more measurements. The third set (S3) may fully or partially contain the first set (S1) or the second set (S2) or may be different from both the first set (S1) and the second set (S2). In one embodiment, the UE may further indicate the obtained information of Tx to another node, e.g., to a network node, to another UE, etc.

In one embodiment, the UE obtains information about the first time instance (Ta), the second time instance (Tb), and/or the time duration (Tx) (in the first, second, and/or third embodiments above) based on: (a) one or more pre-defined rules, (b) information received from a network node, (c) autonomous determination by the UE, or any combination of two or more of (a)-(c).

There are, proposed herein, various embodiments which address one or more of the issues disclosed herein. Embodiments of a method performed by a UE are disclosed. In one embodiment, the method comprises one or more of the following:
receiving, from a network node, information that indicates one or more pre-configured measurement gap patterns;
determining that a first set of one or more conditions for using a pre-configured measurement gap pattern is satisfied, the pre-configured measurement gap pattern being one of the one or more pre-configured measurement gap patterns;
determining a time instance at which to start using the pre-configured measurement gap pattern; and
starting performance of measurements using the pre-configured measurement gap pattern at the determined time instance.

In one embodiment, the information that indicates the one or more pre-configured measurement gap patterns comprises, for each pre-configured measurement gap pattern of the one or more pre-configured measurement gap patterns, information that indicates one or more parameters that define the pre-configured measurement gap pattern. In one embodiment, the one or more parameters comprise a measurement gap length, a measurement gap repetition period, and a measurement gap time offset with respect to a reference time.

In one embodiment, the first set of one or more conditions comprises a condition that one or more reference signals used for the measurements are not fully within a bandwidth of an active bandwidth part of the UE.

In one embodiment, the method further comprises performing measurements in an active bandwidth part of the UE and performing an active bandwidth part switching procedure to a new active bandwidth part, wherein the first set of one or more conditions comprises a condition that one or more reference signals used for the measurements are not fully within a bandwidth of the new active bandwidth part of the UE.

In one embodiment, the first set of one or more conditions comprises a condition that the UE is configured to perform the measurements on an active bandwidth part of the UE and one or more reference signals used for the measurements are not fully within a bandwidth of the active bandwidth part of the UE.

In one embodiment, the determined time instance is a reference time, T0, plus a time offset, DT1. In one embodiment, the reference time, T0, is a time at which the UE received a request to perform the measurements, a time at which the UE informed a network node that the UE will use the pre-configured measurement gap pattern, or a time at which the UE receives a message from a network node that indicates that the UE is permitted to use the pre-configured measurement gap pattern.

In one embodiment, the first set of one or more conditions comprises a condition that the UE is switched from non-dormant to dormant bandwidth part. In one embodiment, the determined time instance is a reference time, T0, plus a time offset, DT1, and the reference time, T0, is a time at which the UE was switched from non-dormant to dormant BWP or a time at which switching of the UE from non-dormant to dormant BWP is complete.

In one embodiment, determining the time instance at which to start using the pre-configured measurement gap pattern comprises determining the time instance at which to start using the pre-configured measurement gap pattern based on one or more predefined rules and/or information received from a network node about one or more parameters related to the determined time instance.

In one embodiment, determining the time instance at which to start using the pre-configured measurement gap pattern comprises determining the time instance at which to start using the pre-configured measurement gap pattern autonomously at the UE.

In another embodiment, a method performed by a UE comprises one or more of the following:
receiving, from a network node, information that indicates one or more pre-configured measurement gap patterns;
performing measurements in an active bandwidth part of the UE using a preconfigured measurement gap pattern, the pre-configured measurement gap pattern being one of the one or more pre-configured measurement gap patterns;
determining that a second set of one or more conditions for stopping use of a pre-configured measurement gap pattern is satisfied;
determining a time instance at which to stop using the pre-configured measurement gap pattern; and
stopping use of the pre-configured measurement gap pattern at the determined time instance.

In one embodiment, the information that indicates the one or more pre-configured measurement gap patterns comprises, for each pre-configured measurement gap pattern of the one or more pre-configured measurement gap patterns, information that indicates one or more parameters that define the pre-configured measurement gap pattern. In one embodiment, the one or more parameters comprise a measurement gap length, a measurement gap repetition period, and a measurement gap time offset with respect to a reference time.

In one embodiment, the second set of one or more conditions comprises a condition that one or more reference signals used for the measurements are fully within a bandwidth of an active bandwidth part of the UE.

In one embodiment, the method further comprises performing an active bandwidth part switching procedure to a new active bandwidth part, wherein the second set of one or more conditions comprises a condition that one or more reference signals used for the measurements are fully within a bandwidth of the new active bandwidth part of the UE.

In one embodiment, the determined time instance is a reference time, T0, plus a time offset, DT2.

In one embodiment, determining the time instance at which to stop using the pre-configured measurement gap pattern comprises determining the time instance at which to stop using the pre-configured measurement gap pattern based on one or more predefined rules and/or information received from a network node about one or more parameters related to the determined time instance.

In one embodiment, determining the time instance at which to stop using the pre-configured measurement gap pattern comprises determining the time instance at which to stop using the pre-configured measurement gap pattern autonomously at the UE.

In one embodiment, the second set of one or more conditions comprises a condition that a number of active bandwidth part switches that has occurred in a respective cell during a defined or (pre-)configured time period (e.g., last N time units, last N seconds, or the like) is less than a threshold number.

In one embodiment, the second set of one or more conditions comprises a condition that is based on a time period between successive active bandwidth part switches that require the UE to change between a bandwidth part measurement procedure that does not use measurement gaps and a gap based measurement procedure that does use measurement gaps.

In one embodiment, the second set of one or more conditions comprises a condition that is based on a time period over which the UE has been using a gap based measurement procedure (e.g., using the pre-configured measurement gap pattern) for performing the measurements.

In another embodiment, a method performed by a UE comprises one or more of the following:
receiving, from a network node, information that indicates one or more pre-configured measurement gap patterns;
determining that a third set of one or more conditions for using a pre-configured measurement gap pattern is satisfied, the pre-configured measurement gap pattern being one of the one or more pre-configured measurement gap patterns;
determining a time duration over which to use the pre-configured measurement gap pattern; and
performing measurements using the pre-configured measurement gap pattern over the determined time duration.

In one embodiment, the information that indicates the one or more pre-configured measurement gap patterns comprises, for each pre-configured measurement gap pattern of the one or more pre-configured measurement gap patterns, information that indicates one or more parameters that define the pre-configured measurement gap pattern. In one embodiment, the one or more parameters comprise a measurement gap length, a measurement gap repetition period, and a measurement gap time offset with respect to a reference time.

Certain embodiments may provide one or more of the following technical advantage(s).
Embodiments of the methods disclosed herein may define UE behavior for using pre-configured measurement gaps for performing measurements at a well-defined time instance known to both UE and serving cell(s). This allows the serving cell to adapt the scheduling of signals to the UE. This also allows the UE to adapt the measurement sampling of the ongoing measurements.
Embodiments of the methods disclosed herein may define UE behavior for switching from using pre-configured measurement gaps to active BWP for performing measurements at a well-defined time instance known to both UE and serving cell(s). This allows the serving cell to adapt the scheduling of signals to the UE. This also allows the UE to adapt the measurement sampling of the ongoing measurements.
Embodiments of the solution(s) disclosed herein may ensure that the scheduling grants/resources are not wasted upon UE switching between pre-configured measurement gaps and active BWP for performing measurements.
Embodiments of the solution(s) disclosed herein may enhance the performance of measurements regardless of whether they are fully or partially done using pre-configured measurement gaps or within the active BWP.
Embodiments of the solution(s) disclosed herein may enable the UE to continue performing measurements regardless of whether the reference signals used for measurements remain within the active BWP or not during the measurement time.

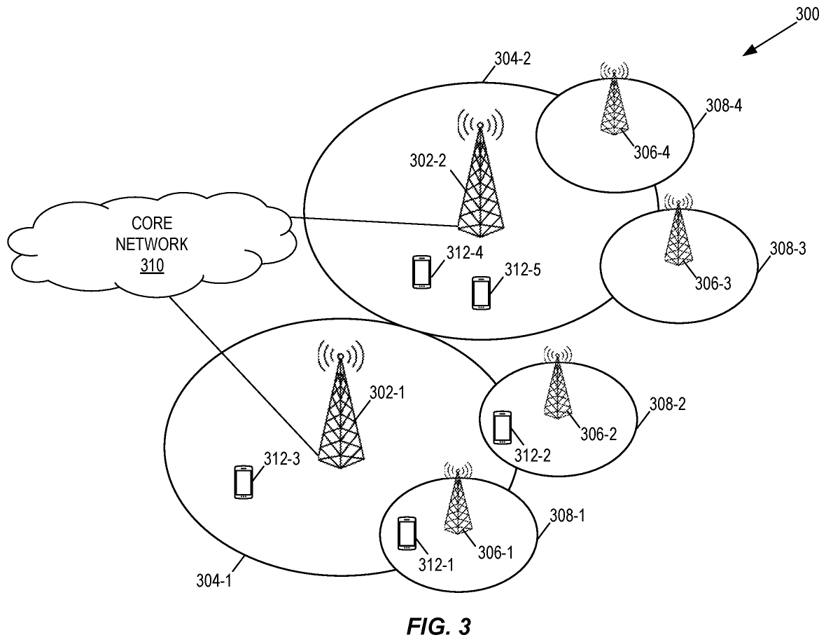

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 302-1 and 302-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to UEs 312-1 through 312-5 in the corresponding cells 304 and 308. The UEs 312-1 through 312-5 are generally referred to herein collectively as UEs 312 and individually as UE 312.

Now, the description turns to various embodiments of the solution(s) disclosed herein. The embodiments disclosed herein relate to a scenario in which a UE 312 served by at least one serving cell (cell1) belonging to carrier frequency (F1) is configured to perform one or more measurements on reference signals (RS) operated by one or more cells on one or more carrier frequencies, e.g., serving carrier, non-serving carrier, etc. The UE 312 may also be configured with two or more serving cells in multicarrier operation (MC), e.g., one or more special cells (SpCell), and/or one or more SCells. Examples of MC operation are carrier aggregation (CA), multi-connectivity (MuC), etc. Examples of MuC are dual connectively (DC), E-UTRA-NR DC (EN-DC), NR-DC, NR-E-UTRA DC (NE-DC), etc. Examples of SpCell are PCell, PSCell, etc. The UE 312 can operate with all carriers in licensed spectrum or without Clear Channel Assessment (CCA, e.g., as described in 3GPP TS 38.133), or at least with one carrier can be in unlicensed spectrum or with CCA.

The UE 312 is further configured by a network node (e.g., base station 302) with at least one measurement gap pattern (MGP) with certain measurement gap length (MGL) (e.g., 6 ms) and measurement gap repetition period (MGRP) (e.g., 40 ms). The measurement gaps can be per-UE or per-FR measurement gaps. The UE may anytime be configured by the network node to switch the active BWP(s) on one or more serving cells based on any active BWP switching mechanism such as, e.g., timer based active BWP switching, DCI based active BWP switching, or RRC based active BWP switching.

Measurement is done by the UE 312 typically during one or multiple measurement occasions (MOs). During each MO, the UE 312 may obtain one or more samples or snapshots which may be combined (e.g., averaged) over a measurement time (e.g., measurement period, L1 period, evaluation period, etc.) to obtain measurement results (e.g., NR-RSRP, NR-RSRQ, NR-SINR, etc.). The measurement results are used by the UE 312 for one or more tasks, e.g., reporting results to the network node, for cell change, etc. The MO may typically be created at periodic intervals to contain the RSs (e.g., SSB burst, CSI-RS, and/or PRS burst) used for measurements, e.g., once every 40 ms. Examples of MOs are measurement gaps within MGP, measurement duration containing RSs within an active BWP, etc.

The UE 312 may perform one or more measurements on one or more serving carriers within active BWP when RSs on which measurements are done are fully within the active BWP. This measurement mechanism or procedure or scheme where the UE 312 measures within the active BWP is referred to herein as an active BWP based measurement procedure (BMP). In BMP, the UE 312 measures without measurement gaps. Therefore, BMP may also be referred to herein as a measurement procedure without gaps or a non-gap-based measurement procedure or a gapless measurement procedure. Corresponding measurement may be referred to herein as a BWP based measurement or a BWP assisted measurement. A BWP based measurement may also be referred to herein as a non-gap-based measurement or a measurement without gaps or a measurement done outside the gaps. BMP may also be referred to herein as a first measurement procedure (MP1). For consistency, BMP is mainly used in the description of the embodiments below.

The UE 312 may perform one or more measurements on one or more serving carriers using a MGP (i.e., within the gaps) when RSs on which measurements are done are not fully within the bandwidth (BW) of the active BWP, e.g., after active BWP switching. This measurement mechanism or procedure or scheme where the UE 312 measures using a MGP is referred to herein as a gap-based measurement procedure (GMP). A GMP may also be referred to herein as a measurement procedure outside active BWP or without active BWP. The corresponding measurement may be referred to herein as a gap-based measurement or a gap assisted measurement or a measurement done outside the active BWP. GMP may also be referred to herein as a second measurement procedure (MP2).

Thanks to active BWP switching, the UE 312 may correspondingly switch between BMP and GMP for performing measurements on one or more carriers. This depends on whether RSs for measurements are within the new active BWP or not after each active BWP switching. Upon switching from GMP to BMP, the measurement gap pattern is not deconfigured. This allows the UE 312 to restart the gaps when switching back from BMP to GMP. This approach avoids reconfiguration of gaps, which reduces signaling overheads, reduces delay in starting GMP, reduces processing in UE and BS, etc. Therefore, the MGP in the present disclosure is also referred to as pre-configured MGP or already configured MGP etc. The pre-configured MGP can be used/activated not necessarily immediately upon first configuration (e.g., by a network node) but at a later stage (e.g., activation triggered by a condition or criteria as described more below), and its usage can be activated/triggered multiple times without another configuration message from a network node.

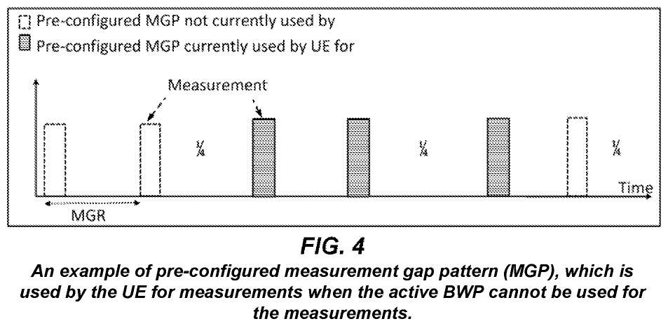

FIG. 4 illustrates an example in which the UE 312 is pre-configured with MGP to perform measurements. The UE 312 uses the MGP for example when the RSs used for measurements are not fully contained within the active BWP.

### Embodiment #1: Method in UE of Using MGP for Measurement Upon Meeting One or More Conditions

According to a first embodiment, the UE 312 upon fulfilling a first set (S1) of one or more conditions or criteria is triggered to use at least one pre-configured MGP for performing one or more measurements (e.g., on one or more cells of one or more carriers). Upon the trigger, the UE 312 further obtains information about a time instance (Tg) at which the UE 312 is to start using the pre-configured MGP and starts using the pre-configured MGP for performing one or more measurements from the obtained time instance (Tg). The reason for starting the use of the MGP at the certain time instance (Tg) is to ensure that both UE 312 and serving BS 302 are aware when the UE 312 will start using the pre-configured MGP for measurement. This allows the serving BS 302 to continue scheduling the UE 312 also during the (unused) measurement gaps in the pre-configured MGP before or until the time instance, Tg. The reason is that the measurement gaps in the pre-configured MGP are configured but are not used (or created) by the UE 312 until the time instance Tg. A rule can be defined to ensure that the UE can be scheduled by the serving network node (e.g., serving BS), during the pre-configured MGP when the MGP is not used by the UE for measurement. For example, the rule can be that the UE is able to receive and/or transmit signals (e.g., receive PDCCH/PDSCH and/or transmit PUCCH/PUSCH) during the pre-configured MGP when the MGP is not used by the UE for measurement. For example, when the UE is performing measurement without gaps (e.g., within active BWP) then the UE may not use the pre-configured MGP for measurement. Yet another rule can be defined to ensure that the serving network node (e.g., serving BS) does not schedule the UE during the pre-configured MGP when the MGP is used by the UE for measurement. For example, the rule can be that the UE is not expected or required to receive and/or not expected or required transmit signals (e.g., not receive PDCCH/PDSCH and/or not transmit PUCCH/PUSCH) during the pre-configured MGP when the MGP is used by the UE for measurement. For example, when the UE is unable to perform measurement within active BWP then the UE may have to use pre-configured MGP for measurement.

Prior to triggering the need for measurement gaps (i.e., prior to triggering the use of the pre-configured MGP), the UE 312 may or may not be performing the measurements within the active BWP.

Conditions or criteria that trigger the UE 312 to use the pre-configured MGP may occur at time instance T0. Therefore, DT1=Tg−T0, is the duration starting from T0 and after which the UE 312 starts using the pre-configured MGP. DT1 is also referred to herein as transition time for the UE 312 to switch or change from the BMP to GMP for performing the measurements on the RSs. DT1 may also comprise an additional time to the beginning of the first full measurement occasion (e.g., when RSs to be measured are available) after the time when the UE 312 is able to use the pre-configured MGP. For periodic RSs, this additional time can be up to the RS periodicity.

The conditions or criteria that trigger the UE 312 to use the pre-configured MGP include one or more of the following. Note, however, that the conditions or criteria listed below are only examples.
1. The UE 312 is performing measurements within the active BWP (e.g., BWP1), and the active BWP switching from BWP1 to BWP2 results in that the BW of the new active BWP (BWP2) does not fully contain the RSs used for measurements being performed. Therefore, the UE 312 cannot continue the ongoing measurements within BWP2. Therefore, the UE 312 has to switch from BMP to GMP (i.e., use of the pre-configured MGP is triggered). In this case, in one example, T0 is the time instance when active BWP switch is triggered, i.e. started. In another example, T0 is the time instance when active BWP switch is completed.
2. The UE 312 is not doing any measurement. But the BW of its current active BWP (e.g., BWP2) does not fully contain the RSs which may be used for measurements. The UE 312 is configured to perform measurements on the RSs. Therefore, the UE 312 cannot perform measurements within BWP2. In other word, the UE 312 cannot perform the measurement without gaps when the active BWP is BWP2. Therefore, the UE 312 has to start the measurement using GMP. In this case, in one example, T0 is the time instance when the UE 312 received requests to perform the measurements.
3. The UE 312 is triggered to perform one or more positioning measurements (e.g., RSTD, PRS-RSRP, UE Rx-Tx time difference etc.) regardless of whether the BW of its current active BWP (e.g., BWP2) fully contains RSs for positioning measurements or not. The UE 312 may be triggered to perform positioning measurements based on internal request or based on assistance information (e.g., via LPP received from positioning node (e.g., LMF etc.) or via RRC received from a serving node. In this case, in one example, T0 is the time instance when the UE 312 received requests to perform the measurements. In another example, T0 is the time instance when the UE 312 informs the network node (e.g., serving BS) that the UE 312 needs to use the pre-configured MGP for performing the positioning measurements. In another example, T0 is the time instance when the UE 312 receives an acknowledgment message or permission or indication from the network node (e.g., serving BS) that the network has received the UE message or that the UE 312 can use the pre-configured MGP for performing the positioning measurements.
4. Active BWP for the UE 312 is switched from non-dormant to dormant BWP by which the UE 312 is not required to monitor PDCCH but still has to carry out RRM (e.g., on SSB) and CSI measurements (e.g., on SSB and/or CSI-RS) on the dormant serving carrier. In order to facilitate UE power saving, the UE 312 is allowed to turn off reception on the concerned dormant serving carrier during times not needed for reception of RSs for RRM and/or CSI measurements. When the UE 312 turns reception on or off, there may be transient disturbances, so called interruptions, during which reception and/or transmission cannot be guaranteed on serving carriers in the same FR or in any FR, depending on UE capability with respect to per-FR gap. A per-FR gap capable UE only causes disturbances (e.g., interruptions) to serving carriers within the same FR; otherwise, disturbances (e.g., interruptions) may be caused to serving carriers in both same and other FRs. The UE 312 may be configured with pre-configured measurement gaps (via the pre-configured MGP) to be used by the UE 312 for radio switching for receiving RSs for RRM and/or CSI measurement, such that the interruptions do not interfere with scheduled traffic to and from the UE 312 on any of the serving carriers. In this case, in one example, T0 is the time instance when active BWP switching from non-dormant to dormant BWP is triggered (started). In another example, T0 is the time instance when active BWP switching from non-dormant to dormant BWP is completed. In this example, a measurement gap may be used for hiding interruption when turning reception on for the dormant carrier, and/or for hiding interruption when turning reception off for the dormant carrier. The actual measurements on RSs (i.e., other than turning receiver on and off) on the dormant carrier can be done without interrupting any serving carrier and hence can be carried out within or outside measurement gaps.

The UE 312 obtains information about the time instance, Tg, at which to start using the pre-configured MGP based on one or more of the following principles:
1. Pre-defined rule, e.g., DT1, T0, Tg may be pre-defined.
2. By receiving information about DT1, T0, Tg from the network node, e.g., from serving BS.
3. Autonomously determined by the UE 312. In this case, the UE 312 further informs the determined parameter values (e.g., DT1) to the network node.

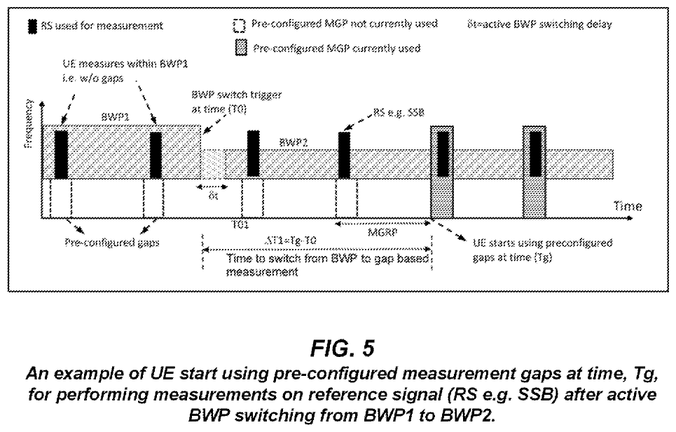

To illustrate the meaning of the time instance (Tg) at which the UE 312 will switch to GMP for measurements since the conditions or criteria for using GMP were triggered is described by an example in FIG. 5. In this example, the UE 312 is served by cell1 (e.g., SpCell, SCell). Initially, certain RSs (e.g., SSB1) are within the BW of the current active BWP (BWP1). Therefore, the UE 312 initially performs one or more intra-frequency measurements or measurements on carrier of cell1 on RSs (e.g., SSB1) according to BMP, i.e. in BWP and without MGP. The UE 312 is triggered at time instance, T0, to switch its active BWP from BWP1 to BWP2 on cell1. The active BWP switching from BWP1 to BWP2 takes place over a time period dt, starting from T0. The RSs are not fully within the BW of the new active BWP (BWP2). This triggers the UE 312 to switch from BMP to GMP to continue performing the measurements on the same RSs (e.g., SSB1). In principle, the UE 312 may start the pre-configured MGP immediately after it has switched to BWP2. However, as shown in FIG. 5, the UE 312 starts the GMP from the first measurement gap in the pre-configured MGP starting at time instance, Tg, i.e., DT1 after T0. This allows the UE 312 and the serving base station 302 to adapt to the new measurement procedure (i.e., GMP) and allows the base station 302 to schedule signals to the UE 312.

The parameters DT1 and Tg are obtained by the UE 312 and the network node (e.g., serving BS 302) based on one or more rules or principles or mechanism, which are described with several examples below:
1. In one example DT1 comprising a function of a, dt and M1, i.e., DT1=f1(a, dt, M1). A specific example of DT1 comprising: DT1=a+dt+M1*MGRP; where a is a margin (e.g., a=X1 number of time resources), as special case a=0; dt=active BWP switching delay, and M1≥1.
2. In another example DT1 comprising a function of a, dt and Tue1, Tbs1 i.e. DT1=f2(a, dt, Tue1, Tbs1). One specific example of DT1 comprising: DT1=a+dt+f3(Tue1, Tbs1). Another specific example of DT1 comprising: DT1=a+dt+MAX(Tue1, Tbs1). Where: Tue1=time required by the UE to adapt to new measurement procedure since measurement sampling may be different in the two procedures and Tbs1=time required by the BS to adapt the scheduling (e.g., stop scheduling in unused pre-configured gaps) when the UE switches from gapless measurement procedure to gap based measurement procedure,
3. In another example DT1 comprising M2 occurrences of measurement gaps or M3 number of MGRPs since the triggering of the conditions (e.g., active BWP switch, positioning measurement request sent by UE, UE is allowed by BS to use MGP etc.) which requires the UE to use GMP for doing the measurements.
4. In another example DT1 may further depend on time period (dt1) between the moment the active BWP switch is triggered or when the active BWP switch is completed (T0) and the moment when the first gap of the pre-configured MGP occurs (T01) immediately after the triggering or completion of the active BWP switch. Where dt1=(T01−T0). DT1 may further depend on dt1 and MGP related parameters (e.g., MGRP). This is explained with few specific examples below:
   In one example if dt1 is below or equal to threshold (D1) then the value of DT1 is larger compared to the case when dt1 is above D1.
   In another example if dt1≤D1 then DT1>Q1*MGRP; but if dt1>D1 then DT1≤Q1*MGRP. Where Q1 is integer. As special case P=1.
   In another example if dt1≤D1 then the UE starts the GMP after at least one occurrence of gap after the active BWP switch is complete; but if dt1>D1 then UE starts the GMP from the first occurrence of gap after the active BWP switch is complete.
5. In another example after the meeting the conditions (e.g., active BWP switching) which requires the UE to use GMP for measurements, the UE starts using the first gap at certain time resource expressed by system frame number (SFN) (e.g., any SFN from 0 to 1024) and subframe (SF) number (e.g., any SF from 0 to 9) meeting following conditions:
   SFN mod T=FUNCTION (K1, gapOffset)/10);
   subframe=gapOffset mod 10;
      with T=FUNCTION (K1, MGRP)/10
   Where:
   Examples of FUNCTION are FLOOR, CEILING, MAXIMUM, MINIMUM, PRODUCT etc.
In one specific example the UE starts using the first gap for measurements at certain SFN and subframe number meeting the following conditions
   SFN mod T=FLOOR((K1+gapOffset)/10);
   subframe=gapOffset mod 10;
      with T=K1*MGRP/10
   Where:
   gapoffset is an integer. As an example, gapoffset varies from 0, 1, 2, . . . , 159. gapoffset may further depend on the MGRP of the MGP, e.g., gapoffset=MGRP−1.
   K1 is an integer, e.g., K1≥1. In one example K1 may be the same for any MGP, e.g., K1=2. In another example K1 may depend on or is function of one or more parameters (e.g., MGRP) related to or defining the MGP. In another example K1 may further depend on active BWP switching delay. This is explained with few specific examples below:
      In one example, where K1=f4(MGRP); K1 is smaller for larger value of MGRP and K1 is larger for smaller value of MGRP. In a specific example: K1=2, if MGRP≤40 ms; and K1=1, if MGRP>40 ms. In another specific example: K1=4, 2, and 1 for MGRP=20 ms, MGRP=40 ms and MGRP>40 ms respectively.
      In another example, K1=f5(dt, MGRP). In one specific example: K1=CEIL(dt/MGRP)*MGRP. In another specific example: K1=FLOOR(dt/MGRP)*MGRP.
      In another example, K1=f6(a, dt, MGRP). In one specific example: K1=CEIL((a+dt)/MGRP)*MGRP. In another specific example: K1=FLOOR((a+dt)/MGRP)*MGRP.
   In another example K1 may further depend on time period (dt1) between the moment the active BWP switch is triggered or when the active BWP switch is completed (T0) and the moment when the first gap of the pre-configured MGP occurs (T01) immediately after the triggering or completion of the active BWP switch. Where dt1=(T01−T0). K1 may further depend on dt1 and MGP related parameters (e.g., MGRP). This is explained with few specific examples below:
      In one example if DO is below or equal to threshold (D1) then the value of K1 is larger compared to the case when dt1 is above D1. For example, K1=q1 when dt1≤D1; and K1=q2 when DU>D1, where q1>q2. In one specific example D1=20 ms, q1=2 and q2=1. This mechanism gives sufficient transition time to the UE for starting/switching to the GMP when the active BWP switch occurs too close to the gap.
      In another example where K1 depends on both dt1 and MGRP, when Dt1≤D1 and MGRP is below or equal to threshold (R1) then K1 is larger compared to the other values of dt1 and MGRP. For example, q1=4 when dt1≤D1 and MGRP≤R1 and q1=1 otherwise. This mechanism also gives sufficient transition time to the UE for starting/switching the GMP when the active BWP switch occurs too close to the gap.
6. In another example after the meeting the conditions (e.g., active BWP switching) which requires the UE to use GMP for measurements, the UE uses the first gap for measurements at SFN and SF meeting the conditions as described in example #5. However, the UE uses the subsequent gaps at SFN and SF meeting the following conditions:
   SFN mod T=FLOOR(gapOffset/10);
   subframe=gapOffset mod 10;
   with T=MGRP/10
7. In another example of measurement scenario: the UE may already be using the pre-configured MGP for performing a first set of measurements (e.g., for inter-frequency, inter-RAT measurements etc.), while the UE meets the conditions or criteria (e.g., active BWP switching) which requires the UE to use GMP for a second set of measurements (e.g., intra-frequency measurements). In this case in a first example, the UE starts the GMP procedure for performing the second set of measurement at time Tg (i.e., starts pre-configured MGP DT1 after the BWP switch trigger). In a second example, the UE may start the GMP procedure for performing the second set of measurement any time after the BWP switch trigger. Whether the UE starts GMP for second type of measurement according to the rule in the first example or the second example can be pre-defined or configured by the network node.
8. In the above examples, the parameters M1, M2, M3, K1, Q1, gapoffset etc. can be pre-defined or configured by the network node.

In one embodiment, a measurement comprises two or more samples or snapshots (e.g., cell detection, NR-RSRP, NR-RSRQ, NR-SINR etc.) which are obtained over the measurement time (Tm). Examples of measurement time are measurement period, beam index (e.g., SSB index) detection period, cell detection period, evaluation period for any of in-sync detection, out of sync detection, beam failure detection, candidate beam detection etc. The samples may be partially performed according to BMP and partially performed according to GMP. The combining of the samples to obtain the measurement results is based on one or more rules, which can be pre-defined or configured by the network node.
In one example of the rule the UE continues the ongoing measurement after the transition from BMP to GMP or vice versa. In this case the measurement may be partially performed according to BMP and partially performed according to GMP. This means the UE combines (e.g., average, sum etc.) samples based on both GMP and BMP to obtain the measurement result.
In another example of the rule the UE discards the samples before the transition from BMP to GMP and restarts the ongoing measurement after the transition from BMP to GMP. In this case only the measurement samples obtained during the GMP (i.e., after the transition from BMP to GMP) are used for performing the measurement. If there are multiple transitions during the measurement time, then the UE combines only samples after the last transition to obtain the measurement results.

The measurement time (Tm) of the measurement performed according to BMP and GMP is determined by the UE 312 according to one or more rules, which can be pre-defined or configured by the network node. The UE 312 then performs the measurement over the determined measurement time. Examples of rules are:
In one example the Tm is function of Tmb, Tmg, number of transitions between BMP and GMP (N1) during Tm, transition time (DT1) of each transition, and margin (b1), e.g., Tm=h(Tmb, Tmg, N1, DT1, b1). The function h(.) may depend on whether the UE continues the ongoing measurement after the transition or restarts the measurement after the transition. Examples of functions are sum, maximum, minimum, average, Xth percentile etc. Where: Tmb=measurement time if the measurement is entirely performed according to BMP and Tmg=measurement time if the measurement is entirely performed according to GMP.
   One specific example of Tm=MAX(Tmb, Tmg)+N1*DT1+b1. As special case b1=0 leading to: Tm=MAX(Tmb, Tmg)+N1*DT1. This rule may apply if the UE continues the ongoing measurement after the transition.
   Another specific example of Tm=Tmb+N1*DT1+b1 (i.e., Tmg=0). As special case b1=0 and N1=1 leading to: Tm=Tmb+DT1. This rule may apply if the UE continues the ongoing measurement after the transition.
   Another specific example of Tm=Tmg+N1*DT1+b1 (i.e., Tmb=0). As special case b1=0 and N1=1 leading to: Tm=Tmg+DT1. This rule may apply if the UE continues the ongoing measurement after the transition.
   Another specific example of Tm=SUM(Tmb, Tmg)+DT1+b1 assuming N1=1. As special case b1=0 leading to: Tm=MAX(Tmb, Tmg)+DT1. This rule may apply if the UE restarts the measurement after the transition.

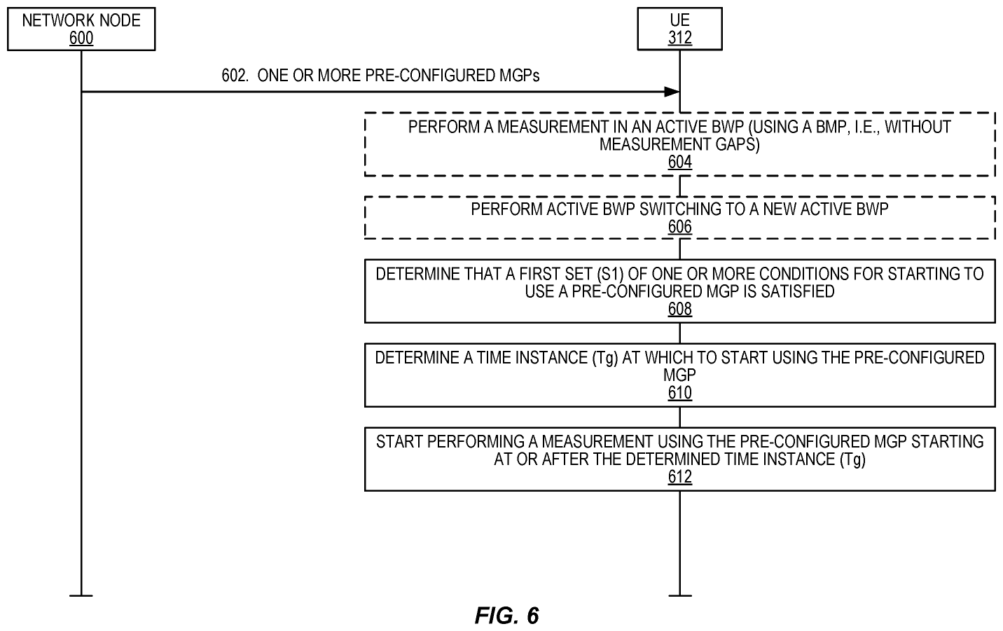

FIG. 6 illustrates the operation of the UE 312 and a network node 600 in accordance with at least some aspects of the first embodiment described above. Optional steps are represented by dashed lines/boxes. The network node 600 may be, for example, the base station 302 of a serving cell of the UE 312, but is not limited thereto. As illustrated, the network node 600 sends, to the UE 312, information that configures one or more pre-configured MGPs for the UE 312 (step 602). For example, for each pre-configured MGP, the information may indicate parameters that characterize or define the pre-configured MGP. As discussed above, these parameters may include a MGL, a MGRP, and a measurement gap time offset with respect to a reference time (e.g., slot offset with respect to the serving cell's SFN such as SFN=0). In the first embodiment, the UE 312 may be configured to perform and thus perform a measurement within an active BWP (e.g., BWP1) using BMP (i.e., without measurement gaps) (step 604). The UE 312 may perform an active BWP switch that results in a new active BWP (e.g., BWP2) for the UE 312 (step 606).

The UE 312 determines that a first set (S1) of one or more conditions (or criteria) for using a pre-configured MGP (i.e., one of the one or more pre-configured MGPs of step 602) is satisfied (step 608). Note that the description above regarding various examples of the first set (S1) of one or more conditions is equally applicable here. For example, the first set (S1) of one or more conditions may include a condition that RS used for measurements (ongoing measurements or measurements to be performed) are not fully contained within the BW of the new active BWP. Other examples are described above. Responsive to determining that the first set (S1) of one or more conditions are satisfied, the UE 312 determines a time instance (Tg) at which the UE 312 is to start using the pre-configured MGP for measurements (using a GMP) (step 610). Note that the description above of various embodiments and examples of how the UE 312 determines, or obtains, the time instance (Tg) are equally applicable here. The UE 312 starts performing a measurement (e.g., the same measurement as performed in step 604) using the pre-configured MGP starting at or after the determined time instance (Tg), as described above (step 612). The UE 312 may continue performing the measurement using the GMP until, e.g., the UE 312 is configured to stop performing the measurement or the UE 312 performs another active BWP switch to a BWP for which the RSs used for the measurement are fully contained within the BW of that BWP (in which case the UE 312 may switch to a BMP that does not use the pre-configured MGP, but in that case the pre-configured MGP remains stored at the UE 312 and may be subsequently used, e.g., in the event of another active BWP switch). It should also be noted that, as described above, the measurements may use samples obtained by the UE 312 before and after starting to use the pre-configured MGP and, in this case, example rules for how such samples are combined are described above.

### Embodiment #2: Method in UE of Using Active BWP for Measurement Upon Meeting One or More Conditions

According to a second embodiment, the UE 312 using at least one pre-configured MGP for measurements on RSs (e.g., SSB), upon fulfilling a second set (S2) of one or more conditions or criteria, is triggered to perform the measurements on the RSs within the active BWP of the UE's serving cell (e.g., cell1) (i.e., triggered to stop using the at least one pre-configured MGP). The triggering conditions enabling the UE to change or switch from GMP to BMP for performing the measurements may comprise an active BWP switching such that after the BWP switching, the RSs used for measurements are fully contained within the BW of the new active BWP. The UE 312 further obtains information about a time instance (Tb) at which the UE is to stop using the pre-configured MGP for performing one or more measurements. The information about the time instance (Tb) is obtained by the UE 312 based on one or more rules, which can be pre-defined, configured by the network node or autonomously determined by the UE. The UE 312 may further transmit the obtained information of Tb to another node (e.g., to a network node, to another UE etc.) especially if determined by the UE 312. The UE 312 may also start applying the BMP for measurements at or after Tb, i.e. performing measurement without gaps. Even when the UE 312 is doing measurements according to BMP, the at least one pre-configured MGP remains configured but is not used for measurements which are done in the active BWP.

The stopping the usage of MGP at certain time instance Tb ensures that both the UE 312 and serving base station 302 are aware of when the UE 312 will stop using the pre-configured MGP for measurement. This allows the serving BS 302 to start scheduling the UE 312 also during the measurement gaps defined by the pre-configured MGP at or after the time instance, Tb. The reason is that the while the measurement gaps are configured but are not used (or created) by the UE 312 for measurements from Tb and onwards. Instead, the UE 312, after Tb, performs measurements within the active BWP, i.e. without MGP.

Conditions or criteria that trigger the UE 312 to stop using the pre-configured gaps may occur at time instance T0. Therefore, DT2=Tb−T0, is the duration starting from T0 and after which (DT2) the UE 312 stops using the pre-configured MGP and start using the new active BWP for measurements. DT2 is also called as transition time for UE 312 to switch or change from the GMP to BMP for performing the measurements on the RSs.

The UE 312 obtains information about the time instance, Tb, at which to stop the pre-configured MGP based on one or more of the following principles:
1. Pre-defined rule, e.g., DT2, T0, Tb may be pre-defined.
2. By receiving information about DT2, T0, Tb from the network node, e.g., from serving BS.
3. Autonomously determined by the UE 312. In this case the UE 312 further informs the determined parameter values (e.g., DT2) to the network node.

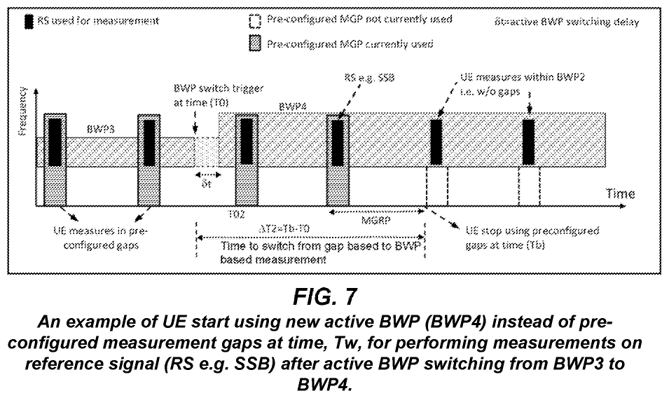

To illustrate the meaning of time instance (Tb) at which the UE 312 will stop the GMP for measurements since the conditions or criteria for using BMP were triggered is described by an example in FIG. 7. In this example the UE 312 is served by cell1 (e.g., SpCell, SCell). Initially certain RSs (e.g., SSB1) are not within the BW of the current active BWP (BWP3). Therefore, the UE 312 initially performs one or more intra-frequency measurements or measurements on carrier of cell1 on RSs (e.g., SSB1) according to GMP, i.e. using pre-configured MGP. The UE 312 is triggered at time instance, T0, to switch its active BWP from BWP3 to BWP4 on cell1. The active BWP switching from BWP3 to BWP4 takes place over a time period DT2, starting from T0. The RSs are fully within the BW of the new active BWP (BWP4). This triggers the UE 312 to switch from GMP to BMP to continue performing the measurements on the same RSs (e.g., SSB1). In principle the UE 312 may stop the pre-configured MGP immediately after it has switched to BWP4. However, as shown in the figure the UE 312 stops the GMP from the first gap starting at time instance, Tb, i.e. DT2 after T0. This allows both UE 312 and the serving base station 302 to adapt to the new measurement procedure (i.e., BMP) and allows the serving base station 302 to schedule signals to the UE 312.

The parameters DT2 and Tb are obtained by the UE 312 based on one or more rules or principles or mechanisms. The rules may also be similar to those described in examples #1 to #7 in the description of Embodiment #1 above. Examples of one or more rules used by the UE 312 and network node for determining DT2 and Tb are further elaborated here with examples:
1. In one example DT2 comprising a function of b, dt, P1 and MGRP, i.e. DT1=g1(b, dt, P1, MGRP). A specific example of DT2 comprising: DT2=b+dt+P1*MGRP. Where b is margin, e.g., b=X1 number of time resources. As special case b=0 and dt=active BWP switching delay. P1≥1.
2. In another example DT2 comprising a function of δ, dt and Tue2, Tbs2, i.e. DT2=g2(β, dt, Tue2, Tbs2). One specific example of DT2 comprising: DT2=β+dt+g3(Tue2, Tbs2). Another specific example of DT2 comprising: DT2=β+MAX(Tue2,Tbs2). Where: Tue2=time required by the UE to adapt to new measurement procedure since measurement sampling may be different in the two procedures and Tbs2=time required by the BS to adapt the scheduling (e.g., start scheduling in unused pre-configured gaps) when the UE switches from gap-based measurement procedure to gapless measurement procedure.
3. In another example DT2 comprising a function of b, dt, P1, Trs_min and Trs, i.e. DT1=g4(b, dt, P1, Trs_min, Trs). A specific example of DT2 comprising: DT2=b+dt+P1*MAX (Trs_min, Trs). Where, Trs=RS occasion periodicity (e.g., SSB or SMTC periodicity), Trs_min=minimum RS periodicity (e.g., min SSB or SMTC periodicity). As special case b=0; Trs_min=Tssb_min=40 ms and dt=active BWP switching delay. P1≥1.
4. In another example DT2 comprising P2 occurrences of measurement gaps or P3 number of MGRPs or P4*MAX (Trs_min, Trs) since the triggering of the conditions (e.g., active BWP switch etc.) which requires the UE to use BMP for doing the measurements. Where P2, P3, P4 are integers.
5. In another example DT2 may further depend on time period (dt2) between the moment the active BWP switch is triggered or when the active BWP switch is completed (T0) and the moment when the first RSs occasion (e.g., SMTC occasion, SSB etc.) occurs (T02) immediately after the triggering or completion of the active BWP switch. Where dt2=(T02−T0). Dt2 may further depend on dt2, Trs_min, Trs, MGP related parameters (e.g., MGRP). This is explained with few specific examples below:
   In one example if dt2 is below or equal to threshold (D2) then the value of DT2 is larger compared to the case when dt2 is above D2.
   In another example if dt2≤D2 then DT2>Q2*MGRP; but if dt2>D2 then DT2≤Q2*MGRP. Where Q2 is integer. As special case Q2=1.
   In another example if dt2≤D2 then DT2>Q2*MAX(Trs_min, Trs); but if dt2>D2 then DT2≤Q2*MAX(Trs_min, Trs).
   In another example if dt2≤D2 then the UE starts the BMP after at least one occurrence of RSs occasion (e.g., SMTC occasion) after the active BWP switch is complete; but if dt2>D2 then UE starts the BMP from the first occurrence of RSs occasion after the active BWP switch is complete.
   In another example if dt2≤D2 then the UE starts the BMP after at least one occurrence of gap after the active BWP switch is complete; but if dt2>D2 then UE starts the BMP from the first occurrence of gap after the active BWP switch is complete.
6. In another example after the meeting the conditions (e.g., active BWP switching) which requires the UE to use BMP for measurements, the UE starts using the first gap at certain time resource expressed by system frame number (SFN) (e.g., any SFN from 0 to 1024) and subframe (SF) number (e.g., any SF from 0 to 9) meeting following conditions:
   SFN mod T=FUNCTION (K2, gapOffset)/10);
   subframe=gapOffset mod 10;
      with T=FUNCTION (K2, MGRP)/10
   Where:
   Examples of FUNCTION are FLOOR, CEILING, MAXIMUM, MINIMUM, PRODUCT etc.
In one specific example the UE starts using the first gap for measurements at certain SFN and subframe number meeting the following conditions
   SFN mod T=FLOOR((K2+gapOffset)/10);
   subframe=gapOffset mod 10;
      with T=K2*MGRP/10
   Where:
      gapoffset is an integer. As an example, gapoffset varies from 0, 1, 2, . . . , 159. gapoffset may further depend on the MGRP of the MGP, e.g., gapoffset=MGRP−1.
   K2 is an integer, e.g., K2≥1. In one example K2 may be the same for any MGP, e.g., K2=2. In another example K2 may depend on or is function of one or more parameters (e.g., MGRP) related to or defining the MGP. In another example K2 may further depend on active BWP switching delay. This is explained with few specific examples below:
      In one example, where K2=g5(MGRP); K2 is smaller for larger value of MGRP and K2 is larger for smaller value of MGRP. In a specific example: K2=2, if MGRP≤40 ms; and K2=1, if MGRP>40 ms. In another specific example: K2=4, 2, and 1 for MGRP=20 ms, MGRP=40 ms and MGRP>40 ms, respectively.
      In another example, K2=g6(dt, MGRP). In one specific example: K2=CEIL(dt/MGRP)*MGRP. In another specific example: K2=FLOOR(dt/MGRP)*MGRP.
      In another example, K2=g7(b, dt, MGRP). In one specific example: K2=CEIL((b+dt)/MGRP)*MGRP. In another specific example: K2=FLOOR((b+dt)/MGRP)*MGRP.
   In another example K2 may further depend on time period (dt2) between the moment the active BWP switch is triggered or when the active BWP switch is completed (T0) and the moment when the first gap of the pre-configured MGP occurs (T02) immediately after the triggering or completion of the active BWP switch. Where dt2=(T02-T0). K2 may further depend on dt2 and MGP related parameters (e.g., MGRP). This is explained with few specific examples below:
      In one example if Dt2 is below or equal to threshold (D2) then the value of K2 is larger compared to the case when dt2 is above D2. For example, K2=p1 when dt2≤D2; and K2=p2 when Dt2>D2, where p1>p2. In one specific example D2=20 ms, p1=2 and p2=1. This mechanism gives sufficient transition time to the UE for starting/switching to the BMP when the active BWP switch occurs too close to the next RSs occasion or occurrence.
      In another example where K2 depends on both dt2 and MGRP, when Dt2≤D2 and MGRP is below or equal to threshold (R2) then K2 is larger compared to the other values of dt2 and MGRP. For example, p1=4 when dt2≤D2 and MGRP≤R2 and p1=1 otherwise. This mechanism also gives sufficient transition time to the UE for starting/switching to the BMP when the active BWP switch occurs too close to the next RSs occasion or occurrence.
6. In another example after the meeting the conditions (e.g., active BWP switching) which requires the UE to use BMP for measurements, the UE uses the first RSs occasion for measurements at SFN and SF meeting the conditions as described in example #5. However, the UE uses the subsequent RSs occasion occurring at next RSs occasion.
7. In the above examples, the parameters P1, P2, P3, P4, K2, gapoffset, Q2, R2, etc. can be pre-defined or configured by the network node.
However, in one example the parameter values (e.g., M1, M2, M3, K1, gapoffset etc.) can be the same as used in the first embodiment. In another example one or more parameter values (e.g., M1, M2, M3, K1, gapoffset etc.) used for deriving DT2 can be different than those used for deriving DT1 (i.e., in the first embodiment).

In another aspect of the second embodiment, the DT2 and Tb may further depend on the number of active BWP switching actions (L1) occurred in cell1 during the last time period Tp (e.g., Tp=Xp number of time resources, Tp time units such as Tp seconds etc.). For example, if L1 is larger than threshold (H1) over the last Tp then the UE does not apply the BMP for performing the measurement even if the conditions to switch from GMP to BMP for performing the measurements are met (e.g., new active BWP fully contains RSs); instead, the UE 312 continues using the MGP for doing the measurements. But if L1 is less than or equal to H1 then the UE applies the BMP for performing the measurement provided that the conditions to switch from GMP to BMP for performing the measurements are met (e.g., new active BWP fully contains RSs) and stops the GMP at Tb. The UE 312 determines DT2 and Tb for stopping GMP as described in previous examples above. One specific example of the rule may comprising as follows: If an active BWP switching occurs while UE 312 is performing a measurement with gaps for the last at least Xp time resources (e.g., Xp slots, subframes etc.) and/or for the last Tp time period, and the new active BWP after the active BWP switching fully contains the measured SSB then the UE 312 shall continue the ongoing measurement without measurement gaps; otherwise the UE shall continue the ongoing measurement using pre-configured gaps.

In another aspect of the second embodiment, the DT2 and Tb may further depend on time period (Ts) between successive active BWP switching actions which require the UE to change between BMP and GMP, e.g., from BMP to GMP or vice versa. For example, if the UE is using GMP and the active BWP switching action (A1) requiring the UE to apply the BMP occurs within or less than Ts since the last active BWP switching (A2) that resulted in UE applying the GMP then the UE does not change from GMP to BMP for doing the measurements. Instead, the UE continues performing the measurements according to GMP.

In another aspect of the second embodiment, the DT2 and Tb may further depend on time period (Tq) over which the UE 312 has been using the GMP for performing the measurements. For example, if the UE 312 has been using GMP for less than or equal to Tq and the active BWP switching action requiring the UE 312 to apply the BMP occurs then the UE 312 does not change from GMP to BMP for doing the measurements. Instead, the UE continues performing the measurements according to GMP. But if the UE 312 has been using GMP for more than Tq and the active BWP switching action requiring the UE to apply the BMP occurs then the UE changes from GMP to BMP for doing the measurements. In this case the UE 312 continues performing the measurements according to BMP and stops the GMP at Tb. The UE determines DT2 and Tb for stopping GMP as described in previous examples above. The time period, Tq, may further depend on one or more parameters related to MGP, e.g., MGRP. Tq may be expressed in terms of number of MGRP, time resources etc. For example, if MGRP is above certain threshold (G1) then Tq is also above certain threshold (G2). But Tq≤G1 when MGRP≤G2.

The parameters in the above rules (e.g., L1, H1, G1, G2, Ts, Tq etc.) can be pre-defined or configured by the network node. The above rules prevent the UE 312 from changing the measurement procedures, (e.g., between BMP and GMP), too frequently. This in turn makes the measurements more stable over their measurement periods. This also ensures the network node can do scheduling more consistently.

The UE 312 may obtain one or more samples or snapshots (e.g., cell detection, NR-RSRP, NR-RSRQ, NR-SINR etc.) when measuring according to GMP and one or more samples or snapshots when measuring according to BMP. The combining of the samples to obtain the measurement results is based on one or more rules, which can be pre-defined or configured by the network node:
In one example of the rule the UE 312 continues the ongoing measurement after the transition from GMP to BMP or vice versa. In this case the measurement may be partially performed according to GMP and partially performed according to BMP. This means the UE combines (e.g., average, sum etc.) samples based on both GMP and BMP to obtain the measurement result.
In another example of the rule the UE discards the samples before the transition from GMP to BMP and restarts the ongoing measurement after the transition from GMP to BMP. In this case only the measurement samples obtained during the BMP (i.e., after the transition from GMP to BMP) are used for performing the measurement. If there are multiple transitions during the measurement time then the UE combines only samples after the last transition to obtain the measurement results.

The measurement time (Tm) of the measurement is further determined by the UE according to one or more rules, which can be pre-defined or configured by the network node. The UE then performs the measurement over the determined measurement time and use it for one or more tasks, e.g., transmits results to network node, cell change etc. Examples of rules are:
In one example the Tm is function of Tmb, Tmg, number of transitions between GMP and BMP (N2) during Tm, transition time (DT2) of each transition and margin (b2), e.g., Tm=g(Tmb, Tmg, N2, DT2, b2). The function may depend on whether the UE continues the ongoing measurement after the transition or restarts the measurement after the transition. Examples of functions are sum, maximum, minimum, average, Xth percentile etc. Where: Tmb=measurement time if the measurement is entirely performed according to BMP and Tmg=measurement time if the measurement is entirely performed according to GMP.
   One specific example of Tm=MAX(Tmb, Tmg)+N2*DT2+b2. As special case b2=0 leading to: Tm=MAX(Tmb, Tmg)+DT2. This rule may apply if the UE continues the ongoing measurement after the transition.
   Another specific example of Tm=Tmb+N2*DT2+b2 (i.e., Tmg=0). As special case b2=0 and N2=1 leading to: Tm=Tmb+DT2. This rule may apply if the UE continues the ongoing measurement after the transition.
   Another specific example of Tm=Tmg+N2*DT2+b2 (i.e., Tmb=0). As special case b2=0 and N2=1 leading to: Tm=Tmg+DT2. This rule may apply if the UE continues the ongoing measurement after the transition.
   Another specific example of Tm=SUM(Tmb, Tmg)+DT2+b2 assuming N2=1. As special case b2=0 leading to: Tm=MAX(Tmb, Tmg)+DT2. This rule may apply if the UE restarts the measurement after the transition.

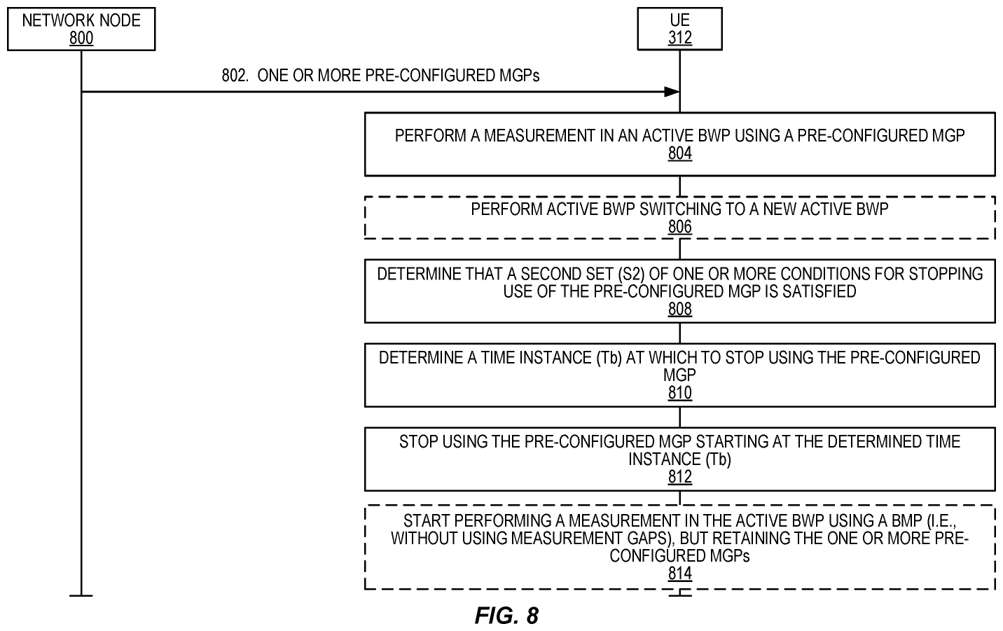

FIG. 8 illustrates the operation of the UE 312 and a network node 800 in accordance with at least some aspects of the second embodiment described above. Optional steps are represented by dashed lines/boxes. The network node 800 may be, for example, the base station 302 of a serving cell of the UE 312, but is not limited thereto. As illustrated, the network node 800 sends, to the UE 312, information that configures one or more pre-configured MGPs for the UE 312 (step 802). For example, for each pre-configured MGP, the information may indicate parameters that characterize or define the pre-configured MGP. As discussed above, these parameters may include a MGL, a MGRP, and a measurement gap time offset with respect to a reference time (e.g., slot offset with respect to the serving cell's SFN such as SFN=0). In the second embodiment, the UE 312 may be configured to perform a measurement and, e.g., as a result of satisfying the first set (S1) of one or more conditions, perform the measurement on its active BWP (e.g., BWP2) using a pre-configured MGP (e.g., one of the pre-configured MGPs configured in step 802) (and a GMP) (step 804). The UE 312 may perform an active BWP switch that results in a new active BWP (e.g., BWP1) for the UE 312 (step 806).

The UE 312 determines that a second set (S2) of one or more conditions (or criteria) for stopping the use of a pre-configured MGP (i.e., one of the one or more pre-configured MGPs of step 802) is satisfied (step 808). Note that the description above regarding various examples of the second set (S2) of one or more conditions is equally applicable here. For example, the second set (S2) of one or more conditions may include a condition that RS used for the measurement (ongoing measurement or measurement to be performed) are fully contained within the BW of the new active BWP. Other examples are described above. Responsive to determining that the second set (S2) of one or more conditions are satisfied, the UE 312 determines a time instance (Tb) at which the UE 312 is to stop using the pre-configured MGP for measurement (stop using the GMP) (step 810). Note that the description above of various embodiments and examples of how the UE 312 determines, or obtains, the time instance (Tb) are equally applicable here. The UE 312 stops performing the measurement using the pre-configured MGP starting at the determined time instance (Tb), as described above (step 812). The UE 312 may then start performing the measurement in the active BWP using BMP (step 814). The UE 312 may continue to perform the measurement using the BMP until, e.g., the UE 312 performs another active BWP switch to a BWP for which the RSs used for the measurement are not fully contained within the BW of that BWP (in which case the UE 312 may switch to a GMP that uses the pre-configured MGP as described above for the first embodiment). It should also be noted that, as described above, the measurement may use samples obtained by the UE 312 before and after stopping the use of the pre-configured MGP and, in this case, example rules for how such samples are combined are described above.

### Embodiment #3: Method in UE of Determining the Duration of Using MGP for Measurement

In a third embodiment the UE 312 is pre-configured with at least one MGP and, upon fulfilling a third set (S3) of one or more conditions or criteria, obtains information about the time duration Tx during which the UE 312 is to use the pre-configured measurement gap pattern for performing one or more measurements. The third set S3 may fully or partially contain the first set S1 of one or more conditions or criteria (see description of Embodiment #1 above) or the second set S2 of one or more conditions or parameters (see description of Embodiment #2 above) or may be different from both S1 or S2.

Some examples of determining Tx:
Example 1: Tx or the maximum duration of Tx is pre-defined or determined based on a pre-defined rule (S3 which may or may not comprise S1), e.g.:
   1. Tx is a fixed pre-defined value,
   2. Tx is a value selected from a set of pre-defined values, e.g., based on S3 (e.g., may or may not comprise S1),
   3. Tx is a measurement time (a.k.a. measurement period) needed for the UE to perform the measurement in the pre-configured MGP,
   Here, the UE can stop using the pre-defined MGP strictly at Tb:
      Tb=Tq+Tx. Tg is defined according to the first embodiment
   Or at time instance min(Tb−Tq,Tx). Tg is according to the first embodiment. Tb is according to the second embodiment.
Example 2: Tx=Tb−Tq. Tb is defined according to the second embodiment. S3 may comprise S2.
Example 3: Tx or the maximum Tx is configured by a network node together with the pre-configured MGP.
   The UE 312 may further indicate the obtained information of Tx to another node, e.g., to a network node, to another UE etc. In case, the maximum Tx is configured by a network node, the UE 312 can still indicate the actual Tx to be used.

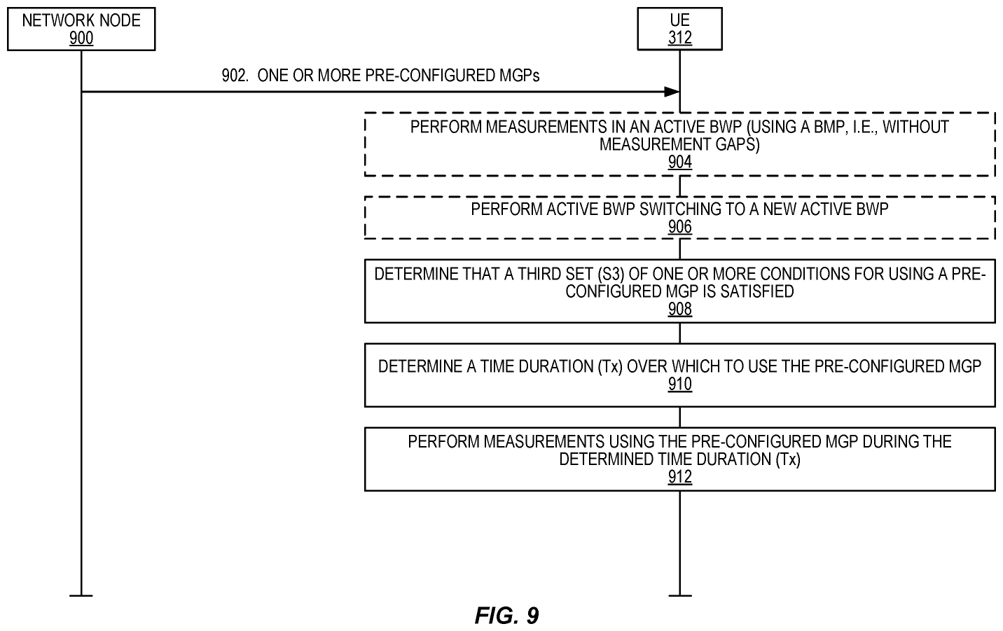

FIG. 9 illustrates the operation of the UE 312 and a network node 900 in accordance with at least some aspects of the third embodiment described above. Optional steps are represented by dashed lines/boxes. The network node 900 may be, for example, the base station 302 of a serving cell of the UE 312, but is not limited thereto. As illustrated, the network node 900 sends, to the UE 312, information that configures one or more pre-configured MGPs for the UE 312 (step 902). For example, for each pre-configured MGP, the information may indicate parameters that characterize or define the pre-configured MGP. As discussed above, these parameters may include a MGL, a MGRP, and a measurement gap time offset with respect to a reference time (e.g., slot offset with respect to the serving cell's SFN such as SFN=0). In the third embodiment, the UE 312 may be configured to perform and thus perform a measurement within an active BWP (e.g., BWP1) using BMP (i.e., without measurement gaps) (step 904). The UE 312 may perform an active BWP switch that results in a new active BWP (e.g., BWP2) for the UE 312 (step 906).

The UE 312 determines that a third set (S3) of one or more conditions (or criteria) for using a pre-configured MGP (i.e., one of the one or more pre-configured MGPs of step 902) is satisfied (step 908). Note that the description above regarding various examples of the third set (S3) of one or more conditions is equally applicable here. Responsive to determining that the third set (S3) of one or more conditions are satisfied, the UE 312 determines a time duration (Tx) during which the UE 312 is to use the pre-configured MGP for measurements (using a GMP) (step 910). Note that the description above of various embodiments and examples of how the UE 312 determines, or obtains, the time duration (Tx) are equally applicable here. The UE 312 performs measurements using the pre-configured MGP for the time duration (Tx) (step 912). For example, the UE 312 may start performing the measurement using the pre-configured MGP at a time instance (Tg) as described above with respect to the first embodiment and continue performing the measurement using the pre-configured MGP for the determined time duration (Tx).

### Further Description

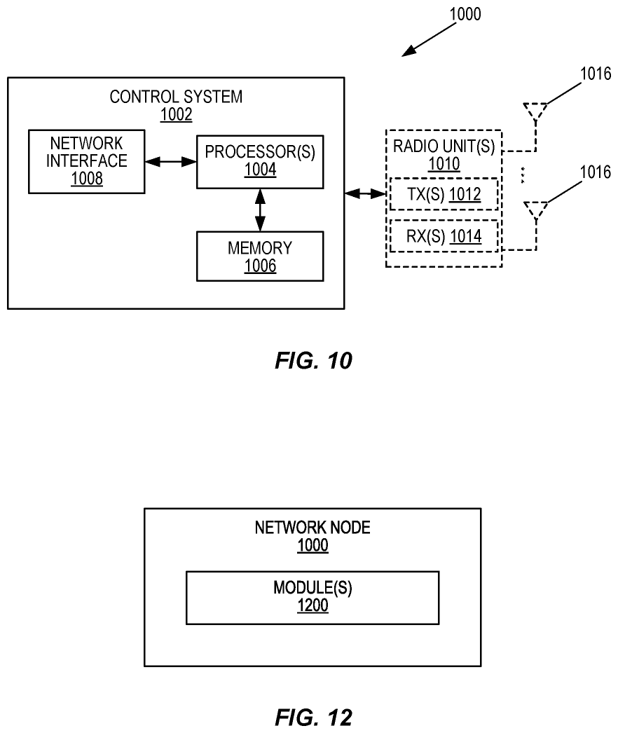

FIG. 10 is a schematic block diagram of a network node 1000 according to some embodiments of the present disclosure. Optional features are represented by dashed boxes. The network node 1000 may be, for example, the network node 600, 800, or 900, a base station 302 such as the serving base station of the UE 312, or a network node that implements all or part of the functionality of the serving base station 302 described herein. As illustrated, the network node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, if the network node 302 is a RAN node (e.g., a base station 302), the network node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of the network node 1000 as described herein (e.g., one or more functions of a network node such as the network node 600, 800, or 900 or the serving base station 302 of the UE 312 as described herein). In some embodiments, the function(s) are implemented in software that is stored, e.g., in the memory 1006 and executed by the one or more processors 1004.

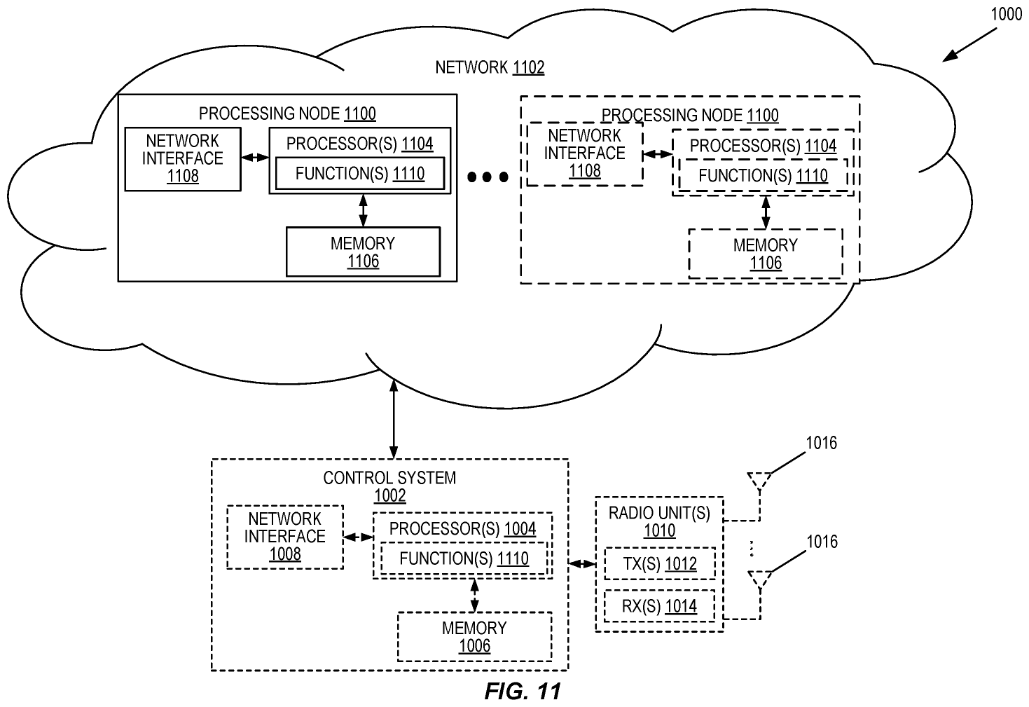

FIG. 11 is a schematic block diagram that illustrates a virtualized embodiment of the network node 1000 according to some embodiments of the present disclosure. Again, optional features are represented by dashed boxes. As used herein, a “virtualized” network node is an implementation of the network node 1000 in which at least a portion of the functionality of the network node 1000 is implemented as a virtual component(s) (e.g., via a virtual machine(s) executing on a physical processing node(s) in a network(s)). As illustrated, the network node 1000 includes one or more processing nodes 1100 coupled to or included as part of a network(s) 1102. Each processing node 1100 includes one or more processors 1104 (e.g., CPUs, ASICs, FPGAs, and/or the like), memory 1106, and a network interface 1108. If the network node 1000 is a RAN node (e.g., a base station 302), the network node 1000 may include the control system 1002 and/or the one or more radio units 1010, as described above. The control system 1002 may be connected to the radio unit(s) 1010 via, for example, an optical cable or the like. If present, the control system 1002 or the radio unit(s) are connected to the processing node(s) 1100 via the network 1102.

In this example, functions 1110 of the network node 1000 described herein (e.g., one or more functions of a network node such as the network node 600, 800, or 900 or the serving base station 302 of the UE 312 as described herein) are implemented at the one or more processing nodes 1100 or distributed across the one or more processing nodes 1100 and the control system 1002 and/or the radio unit(s) 1010 in any desired manner. In some particular embodiments, some or all of the functions 1110 of the network node 1000 described herein (e.g., one or more functions of a network node such as the network node 600, 800, or 900 or the serving base station 302 of the UE 312 as described herein) are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of the network node 1000 or a node (e.g., a processing node 1100) implementing one or more of the functions 1110 of the network node 1000 in a virtual environment according to any of the embodiments described herein (e.g., one or more functions of a network node such as the network node 600, 800, or 900 or the serving base station 302 of the UE 312 as described herein) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the network node 1000 according to some other embodiments of the present disclosure. The network node 1000 includes one or more modules 1200, each of which is implemented in software. The module(s) 1200 provide the functionality of the network node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

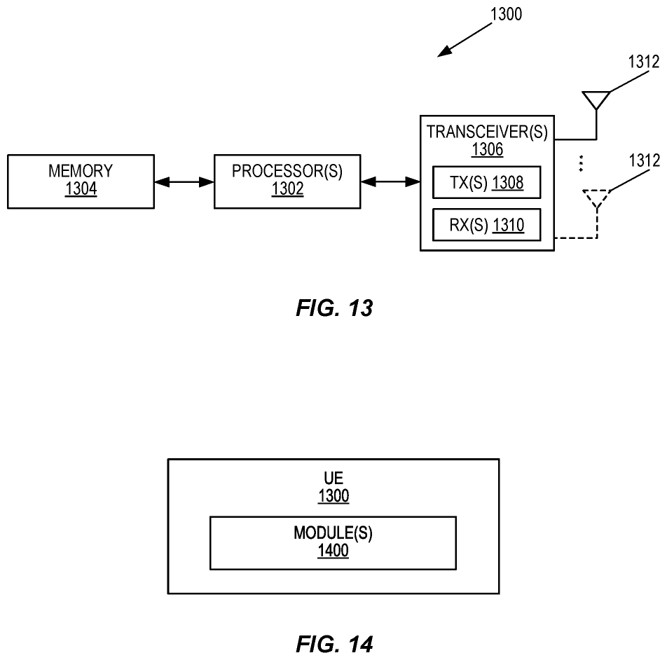

FIG. 13 is a schematic block diagram of a UE 1300, like the UE 312, according to some embodiments of the present disclosure. As illustrated, the UE 312 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the UE 312 described above may be fully or partially implemented in software that is, e.g., stored in the memory 1304 and executed by the processor(s) 1302. Note that the UE 312 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the UE 312 and/or allowing output of information from the UE 312), a power supply (e.g., a battery and associated power circuitry), etc.

In some embodiments, a computer program including instructions which, when executed by at least one processor, causes the at least one processor to carry out the functionality of the UE 312 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the UE 312 according to some other embodiments of the present disclosure. The UE 312 includes one or more modules 1400, each of which is implemented in software. The module(s) 1400 provide the functionality of the UE 312 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node, information that indicates one or more pre-configured measurement gap patterns;
determining that a first set of one or more conditions for using a pre-configured measurement gap pattern is satisfied, the pre-configured measurement gap pattern being one of the one or more pre-configured measurement gap patterns;
determining a time instance at which to start using the pre-configured measurement gap pattern; and
starting performance of a measurement using the pre-configured measurement gap pattern at or after the determined time instance.

2. The method of claim 1 further comprising:
performing a measurement without pre-configured measurement gap pattern before the first set of one or more conditions for using a pre-configured measurement gap pattern is satisfied;
wherein starting performance of the measurement using the pre-configured measurement gap pattern at the determined time instance comprises continuing performing the measurement with the pre-configured measurement gap pattern at or after the determined time instance.

3. The method of claim 2 wherein performing the measurement without pre-configured measurement gap pattern comprises performing the measurement without pre-configured measurement gap pattern within an active bandwidth part of the UE.

4. The method of claim 1 wherein the information that indicates the one or more pre-configured measurement gap patterns comprises, for each pre-configured measurement gap pattern of the one or more pre-configured measurement gap patterns, information that indicates one or more parameters that define the pre-configured measurement gap pattern.

5. The method of claim 4 wherein the one or more parameters comprise a measurement gap length, a measurement gap repetition period, and a measurement gap time offset with respect to a reference time.

6. The method of claim 1 wherein the first set of one or more conditions comprises a condition that one or more reference signals used for the measurements are not fully within a bandwidth of an active bandwidth part of the UE.

7. The method of claim 1 further comprising:
performing a measurement in an active bandwidth part of the UE; and
performing an active bandwidth part switching procedure to a new active bandwidth part;
wherein the first set of one or more conditions comprises a condition that one or more reference signals used for the measurement are not fully within a bandwidth of the new active bandwidth part of the UE.

8. The method of claim 1 wherein the first set of one or more conditions comprises a condition that the UE is configured to perform the measurement on an active bandwidth part of the UE and one or more reference signals used for the measurement are not fully within a bandwidth of the active bandwidth part of the UE.

9. The method of claim 1 wherein the determined time instance at which to start using the pre-configured measurement gap pattern is a reference time, T0, plus a time offset, DT1.

10. The method of claim 9 wherein the reference time, T0, is a time at which the UE received a request to perform the measurement, a time at which the UE informed a network node that the UE will use the pre-configured measurement gap pattern, or a time at which the UE receives a message from a network node that indicates that the UE is permitted to use the pre-configured measurement gap pattern.

11. The method of claim 1 wherein the first set of one or more conditions comprises a condition that the UE is switched from non-dormant to dormant bandwidth part.

12. The method of claim 11 wherein the determined time instance at which to start using the pre-configured measurement gap pattern is a reference time, T0, plus a time offset, DT1, and the reference time, T0, is a time at which the UE was switched from non-dormant to dormant BWP or a time at which switching of the UE from non-dormant to dormant BWP is complete.

13. The method of claim 1 wherein determining the time instance at which to start using the pre-configured measurement gap pattern comprises determining the time instance at which to start using the pre-configured measurement gap pattern based on one or more predefined rules and/or information received from a network node about one or more parameters related to the determined time instance.

14. The method of claim 1 wherein determining the time instance at which to start using the pre-configured measurement gap pattern comprises determining the time instance at which to start using the pre-configured measurement gap pattern autonomously at the UE.

15. The method of claim 1 wherein starting the use of the pre-configured measurement gap pattern comprises activating the pre-configured measurement gap pattern.

16-32. (canceled)

33. A User Equipment (UE) comprising:
one or more transmitters;
one or more receivers; and
processing circuitry associated with the one or more transmitters and the one or receivers, the processing circuitry configured to cause the UE to:
receive, from a network node, information that indicates one or more pre-configured measurement gap patterns;
determine that a first set of one or more conditions for using a pre-configured measurement gap pattern is satisfied, the pre-configured measurement gap pattern being one of the one or more pre-configured measurement gap patterns;
determine a time instance at which to start using the pre-configured measurement gap pattern; and
start performance of a measurement using the pre-configured measurement gap pattern at or after the determined time instance.

34. (canceled)

35. A method performed by a User Equipment (UE), the method comprising:
receiving, from a network node, information that indicates one or more pre-configured measurement gap patterns;
determining that a set of one or more conditions for using a pre-configured measurement gap pattern is satisfied, the pre-configured measurement gap pattern being one of the one or more pre-configured measurement gap patterns;
determining a time duration over which to use the pre-configured measurement gap pattern; and
performing a measurement using the pre-configured measurement gap pattern over the determined time duration.

36. The method of claim 35 wherein the information that indicates the one or more pre-configured measurement gap patterns comprises, for each pre-configured measurement gap pattern of the one or more pre-configured measurement gap patterns, information that indicates one or more parameters that define the pre-configured measurement gap pattern.

37. The method of claim 36 wherein the one or more parameters comprise a measurement gap length, a measurement gap repetition period, and a measurement gap time offset with respect to a reference time.

38. The method of claim 35 wherein the UE is able to receive and/or transmit signals during measurement gaps defined by the pre-configured measurement gap pattern when the pre-configured measurement gap pattern is not used by the UE.

39-42. (canceled)

43. A method performed by a network node for a cellular communications system, the method comprising:
providing, to a User Equipment (UE), information that indicates one or more pre-configured measurement gap patterns; and
providing, to the UE, information that indicates a time instance at which to start using the pre-configured measurement gap pattern.

44. The method of claim 43, further comprising:
providing, to the UE, information that indicates a time instance at which to stop using the pre-configured measurement gap pattern.

45. The method of claim 43 wherein the information that indicates the one or more pre-configured measurement gap patterns comprises, for each pre-configured measurement gap pattern of the one or more pre-configured measurement gap patterns, information that indicates one or more parameters that define the pre-configured measurement gap pattern.

46. The method of claim 45 wherein the one or more parameters comprise a measurement gap length, a measurement gap repetition period, and a measurement gap time offset with respect to a reference time.

47. The method of claim 43 wherein the network node does not schedule the UE during the one or more pre-configured measurement gap patterns when the one or more pre-configured measurement gap patterns are used by the UE.

48-51. (canceled)
